(19) United States
(12) Patent Application Publication
(10) Pub. No.: US 2026/0289514 A1
(43) Pub. Date: Sep. 24, 2026

(54) SYSTEM

(71) Applicant: SoftBank Group Corp., Tokyo (JP)

(72) Inventor: Tsuyoshi TSUKAHARA, Tokyo (JP)

(73) Assignee: SoftBank Group Corp., Tokyo (JP)

(21) Appl. No.: 19/562,925

(22) Filed: Mar. 11, 2026

(30) Foreign Application Priority Data
Mar. 19, 2025 (JP) 2025-044502

(51) Int. Cl. G06Q 10/107; G06F 40/186; G06F 40/30; G06Q 50/20; H04L 51/02

(52) U.S. Cl. CPC G06Q 10/107; G06F 40/186; G06F 40/30; G06Q 50/20; H04L 51/02

(57) ABSTRACT

A system includes a processor that is configured to receive and analyze content of a communication notebook from a guardian, input a prompt sentence into a generative AI model based on an analysis result of the content of the communication notebook and generate a draft reply sentence, and present the generated draft reply sentence to a teacher terminal and allow modification of the draft reply sentence by a teacher.

### CROSS-REFERENCE TO RELATED APPLICATION

This application is based on and claims priority under 35 USC 119 from Japanese Patent Application No. 2025-044502 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional school-home communication, a teacher typically reads a communication notebook sent by a guardian and manually drafts an appropriate reply. This process requires the teacher to consider the emotional state, concerns, and expectations of the guardian while also ensuring accuracy of information and consistency with school policies. As a result, the drafting of replies imposes a substantial workload on teachers, especially when there are many students and frequent communications. Furthermore, the quality and tone of replies can vary among teachers, and it may be difficult to consistently provide responses that enhance the guardian's sense of reassurance and trust. Consequently, there is a need for a system that can support teachers in drafting reply messages efficiently and consistently, while maintaining or improving the communication quality perceived by guardians.

### SUMMARY

In order to solve the above-described problems, a system according to one embodiment of the present invention comprises a processor, wherein the processor is configured to receive and analyze content of a communication notebook from a guardian, input a prompt sentence into a generative AI model based on an analysis result of the content of the communication notebook, and generate a draft reply sentence. The processor is further configured to present the generated draft reply sentence to a teacher terminal and allow modification of the draft reply sentence by a teacher. In addition, the processor is configured to cause the generative AI model to generate the draft reply sentence such that the draft reply sentence includes content that increases reassurance or a degree of trust of the guardian. Furthermore, the processor is configured to reduce working time and maximize communication effectiveness by using the generated draft reply sentence.

The term “processor” refers to one or more hardware computing elements, such as a central processing unit (CPU), a graphics processing unit (GPU), an application specific integrated circuit (ASIC), a field programmable gate array (FPGA), or a combination thereof, that executes instructions to perform the functions described in the present specification.

The term “communication notebook” refers to electronic or digitized content corresponding to a communication medium used between a guardian and a teacher for exchanging information regarding a child, including, for example, text messages, notes, requests, reports, or questions transmitted via an application, web interface, or other electronic means.

The term “guardian” refers to a person who is legally or practically responsible for a child, such as a parent, foster parent, or other caregiver, and who communicates with a teacher through the communication notebook.

The term “generative AI model” refers to a machine learning model, such as a large language model or other generative model, that is capable of generating natural-language text based on an input prompt, and that is used to automatically produce a draft reply sentence.

The term “prompt sentence” refers to text data, generated by the processor based on analysis of the communication notebook content, that is provided as input to the generative AI model to condition or guide generation of the draft reply sentence.

The term “draft reply sentence” refers to one or more sentences or a text message, generated by the generative AI model in response to the prompt sentence, that is intended as a candidate reply from the teacher to the guardian and that may be modified by the teacher.

The term “teacher terminal” refers to an electronic device operated by a teacher, such as a personal computer, tablet, or smartphone, that is capable of displaying the draft reply sentence and receiving input for modifying or approving the draft reply sentence.

The term “reassurance” refers to a psychological state of reduced anxiety or concern of the guardian, which is promoted by the content or tone of the draft reply sentence, such that the guardian feels more secure or relieved regarding the subject of the communication.

The term “degree of trust” refers to a level of confidence of the guardian in the teacher or educational institution, which is influenced by the perceived reliability, sincerity, and appropriateness of the content of the draft reply sentence.

The term “working time” refers to an amount of time required for a teacher to read the communication notebook content, consider an appropriate response, compose a reply, and complete the communication process.

The term “communication effectiveness” refers to a quality or outcome of communication between the guardian and the teacher, including clarity of conveyed information, appropriateness of tone, degree of reassurance and trust obtained by the guardian, and reduction of misunderstandings.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

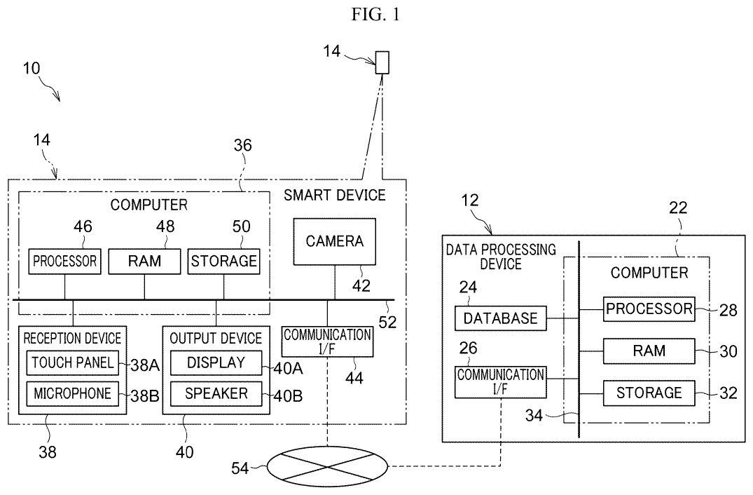

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

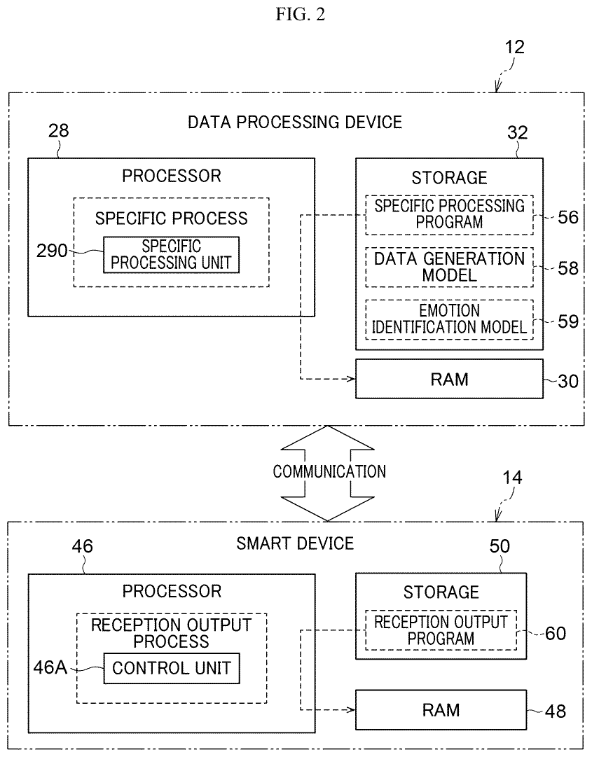

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional information processing environments, communication support and fraud detection are typically implemented as separate, siloed systems executed by generic computer hardware. A first class of systems assists an operator in composing natural language replies to incoming messages, for example from end users or customers, but such systems either rely on static templates or simple rule-based engines. As a result, these systems do not flexibly adapt reply content to the semantic nuance of the incoming message or to the emotional state of the sender, and they place a substantial cognitive and time burden on the operator who must manually edit or rewrite machine-generated drafts. A second class of systems monitors transaction data, such as payment information, to detect potential fraud. These systems often employ fixed heuristics or traditional machine learning models operating on pre-defined feature sets, and require significant manual effort to tune thresholds, interpret results, and integrate them into transaction processing flows. Both classes of systems therefore consume substantial computing resources without proportionate gains in accuracy or throughput, and do not fully exploit more advanced machine learning capabilities such as generative models.

Furthermore, typical computer implementations treat natural language content and structured transaction data as independent data streams processed by different modules or services. The underlying processors execute separate programs that do not share intermediate representations or judgments. This separation leads to redundant data preprocessing, duplicated inference calls, and fragmented logging and auditing. Additionally, generic interfaces to machine learning models usually supply only raw features or fixed-format inputs, without dynamically constructing prompt sentences that reflect intermediate judgments or contextual features. As a consequence, the computer is unable to leverage the reasoning capabilities of generative AI models in a staged manner (for example, primary and final judgments) and cannot systematically refine fraud assessment based on intermediate outputs and derived features. This results in inefficient use of processing cycles, increased latency for real-time decision making, and lower overall detection performance.

Moreover, when generative AI models are used, they are often invoked in an ad hoc manner: input prompts are handwritten, output formats are inconsistent, and there is no standardized mechanism in the processor for generating, controlling, and reusing prompt sentences across multiple decision stages. The processor thus spends additional time and resources on parsing free-form textual outputs, resolving ambiguities, and applying business rules, which degrades scalability and makes system behavior less predictable. It is also difficult to trace and audit how particular model outputs were produced, since prompt construction, model invocation, and decision mapping are not integrated into a unified processing flow executed by the processor.

Accordingly, there is a need for an improved computer-implemented system in which a processor is specifically configured to (i) jointly process message content and transaction information, (ii) automatically generate structured prompt sentences for a generative AI model, (iii) perform staged fraud assessment by obtaining both primary and final judgment results from the generative AI model, and (iv) map these results into standardized examination outcomes and user-facing reply-content candidates. By tightly integrating prompt construction, generative AI inference, and decision mapping within the processor, the computer can more efficiently utilize computing resources, reduce latency, and improve both communication support and fraud detection functions. The technical problem to be solved is therefore to improve the functioning of a computer system by providing specialized processing for generating and controlling prompt sentences, orchestrating multi-stage inference with a generative AI model, and unifying the handling of natural language reply generation and fraud risk evaluation, thereby enhancing processing efficiency, scalability, and reliability over generic, non-specialized computer implementations.

The specific processing by the specific processing unit 290 of the data processing device 12 in Example 1 is realized by the following means.

The present invention provides a server comprising a processor configured to receive, from an information processing apparatus, input information including character information representing message content and transaction information including payment information, to analyze the input information to generate analysis result information, to generate, on the basis of the analysis result information and the input information, a first prompt sentence for generation of a reply-content candidate related to the message content, and to input the first prompt sentence and the analysis result information into a generative AI model so as to cause the generative AI model to generate response information representing the reply-content candidate, to associate the response information with the transaction information as screening input information, to generate a primary-judgment prompt sentence including at least a part of the transaction information, and to input the primary-judgment prompt sentence into the generative AI model so as to obtain a primary-judgment result regarding a possibility of fraud in the transaction information, to generate, on the basis of the primary-judgment result and the transaction information, feature information representing characteristics of the transaction information, to generate a final-judgment prompt sentence including the feature information and the primary-judgment result, and to input the final-judgment prompt sentence into the generative AI model so as to obtain a final-judgment result regarding the possibility of fraud in the transaction information, and to generate examination-result information on the basis of the final-judgment result, output the examination-result information to a terminal apparatus, and cause a display apparatus to present the reply-content candidate and accept a correction operation by a user for the reply-content candidate. This enables the server to improve the operation of the computer by unifying natural language reply generation and staged fraud assessment within a single processor-controlled flow, by programmatically constructing and controlling prompt sentences for the generative AI model, by reducing redundant data processing and manual intervention, by standardizing model outputs into machine-readable examination results, and by thereby enhancing processing speed, scalability, and accuracy in communication support and fraud detection compared with generic, non-specialized computer systems.

The term “system” refers to a combination of one or more hardware components and one or more software components that cooperatively execute processing for handling message content and transaction information, including at least a processor and associated memory and interfaces.

The term “processor” refers to a hardware processing unit, such as a central processing unit or a processing core, that executes machine-readable instructions stored in a memory to perform analysis, generation of prompt sentences, invocation of a generative AI model, and generation of examination-result information.

The term “information processing apparatus” refers to an apparatus including at least one processor and a memory, such as a computing device or a communication device, that is configured to input, store, transmit, or display information including message content and transaction information.

The term “terminal apparatus” refers to an endpoint device, such as a portable communication device, a stationary computing device, or another user-operated device, that is configured to transmit information to and receive information from the server and to present information to a user.

The term “display apparatus” refers to a hardware component, such as a display device or a display unit associated with a user interface, that is configured to visually present information, including a reply-content candidate and examination-result information, to a user.

The term “input information” refers to information received from the information processing apparatus, the information including at least character information representing message content and transaction information including payment information.

The term “character information” refers to data expressed as a sequence of characters or symbols that represent natural language text, including text constituting the message content to which a reply is to be generated.

The term “message content” refers to natural language content included in communication from a sender to a recipient, the communication being, for example, a message, a note, or another textual communication requiring a reply.

The term “transaction information” refers to information related to a transaction, including at least payment information such as an identifier of a payment instrument, a transaction amount, a transaction time, or a transaction location.

The term “payment information” refers to data associated with a payment operation, including at least a payment instrument identifier, a monetary amount, a currency, a timestamp, and optionally device information or network information.

The term “analysis result information” refers to information generated by the processor through analysis of the input information, the analysis result information including, for example, extracted features, classification results, or other processed representations used for subsequent processing.

The term “prompt sentence” refers to a text string or other model input representation constructed by the processor and provided to the generative AI model, the text string defining an instruction, a question, or a description that conditions the output of the generative AI model.

The term “first prompt sentence” refers to a prompt sentence generated on the basis of the analysis result information and the input information, the first prompt sentence being used to cause the generative AI model to generate a reply-content candidate related to the message content.

The term “primary-judgment prompt sentence” refers to a prompt sentence including at least a part of the transaction information and optionally other contextual information, the primary-judgment prompt sentence being used to cause the generative AI model to output a primary-judgment result regarding a possibility of fraud.

The term “final-judgment prompt sentence” refers to a prompt sentence including at least feature information representing characteristics of the transaction information and the primary-judgment result, the final-judgment prompt sentence being used to cause the generative AI model to output a final-judgment result regarding the possibility of fraud.

The term “generative AI model” refers to a machine learning model, such as a generative model trained by data-driven learning, that is configured to generate output data, including natural language text or structured data, in response to an input that includes at least one prompt sentence and optional auxiliary features.

The term “response information” refers to information output from the generative AI model in response to the first prompt sentence, the response information representing a candidate for reply content to the message content.

The term “reply-content candidate” refers to a draft or proposal of natural language reply text generated by the generative AI model, the draft or proposal being subject to presentation to a user and to correction by the user.

The term “screening input information” refers to information that the processor prepares for fraud assessment, the screening input information including at least the response information associated with the transaction information and being used as input to the generative AI model.

The term “primary-judgment result” refers to an output of the generative AI model obtained in response to the primary-judgment prompt sentence, the output indicating an initial assessment regarding a possibility of fraud in the transaction information.

The term “feature information” refers to information generated by the processor on the basis of the primary-judgment result and the transaction information, the information representing derived characteristics, attributes, or statistical measures related to the transaction information.

The term “final-judgment result” refers to an output of the generative AI model obtained in response to the final-judgment prompt sentence, the output indicating a refined or final assessment regarding the possibility of fraud in the transaction information.

The term “examination-result information” refers to information generated by the processor on the basis of the final-judgment result, the examination-result information including at least a classification of the transaction into a category such as safe, possible fraud, or verification required, and being output to the terminal apparatus.

The term “correction operation” refers to an operation performed by a user through a user interface presented on the display apparatus, the operation including at least editing, approving, or modifying the reply-content candidate presented by the processor.

In one embodiment, a server, a terminal, and a user cooperate to implement the claimed system. The server includes at least one processor, a main memory, a non-volatile storage device, a network interface, and a display apparatus or a display interface. The terminal includes at least one processor, a memory, a display device, and a communication interface. The user operates the terminal to input message content and transaction information, and the server executes a program that configures the processor to perform the functions recited in the claims.

The server executes an operating system, such as a general-purpose server operating system, and application software implemented, for example, on a runtime environment such as a script-based web framework or an object-oriented application framework. The server also executes a model inference engine that hosts a generative AI model, for example a transformer-based neural network model loaded into memory and executed on a central processing unit and, in some embodiments, on a graphics processing unit using a parallel computation framework.

The server uses a structured data representation for input information. For example, the server stores message content and transaction information in memory as key-value pairs in an internal record structure, including fields such as “message_text,” “sender_id,” “card_token,” “amount,” “currency,” “timestamp,” “ip_address,” and “device_type.” The server uses an in-memory feature vector representation for model input, where each transaction is represented as a vector of numerical values, categorical encodings, and embeddings derived from text tokens. The server maintains a log storage in the non-volatile storage device, such as a relational database system or a key-value store, for analysis result information, prompt sentences, primary-judgment results, and final-judgment results.

The server analyzes the input information by applying a text analysis module and a structured-data analysis module. The server uses a tokenizer to segment the message content into tokens and applies a natural language preprocessing pipeline, such as lower-casing, stop-word filtering, part-of-speech tagging, and optional sentiment estimation. The server computes semantic features, such as an embedding vector obtained by feeding the tokenized message into an encoder network or by looking up pre-trained word vectors. For transaction information, the server uses a numerical preprocessing library to normalize continuous values, such as scaling amounts into a standard range, converting timestamps into a standard time zone, and encoding categorical attributes into one-hot vectors or integer indices.

The server generates analysis result information that includes, for example, (i) a semantic category of the message content, such as “complaint,” “inquiry,” or “notification”; (ii) an estimated tone, such as “neutral” or “concerned”; and (iii) derived transaction features, such as recent transaction frequency, deviation from usual amount range, and geographic distance between current and prior access locations. The server stores the analysis result information in memory as a structured feature object associated with the current session.

The server constructs a first prompt sentence for generation of a reply-content candidate by combining template segments with elements of the analysis result information and the message content. For example, the server generates a first prompt sentence in natural language such as:
“You are generating a polite and reassuring reply. The following is a message from a sender: ‘[message_text]’. Based on this message, create a reply draft that clearly addresses the sender's concerns and increases the sender's sense of reassurance and trust. Output only the reply text.”

The server dynamically inserts the original message text into the prompt sentence and may add additional instructions according to the detected semantic category or tone. The server does not simply perform string concatenation; instead, the server uses a dedicated prompt-construction module that selects different phrase templates and control directives based on internal rules and feature values. This module thereby reduces ambiguity in model interaction and normalizes the generative AI behavior across different input cases.

The server passes the first prompt sentence and the analysis result information to the generative AI model through a model interface. In one embodiment, the generative AI model is a transformer-based sequence-to-sequence neural network comprising multiple encoder-decoder layers, self-attention mechanisms, and feedforward sublayers, trained on large corpora of natural language text and fine-tuned on domain-specific conversation data. The server converts the prompt sentence into token identifiers, constructs a tensor representation, and feeds the tensor into the model. The model performs a series of matrix multiplications, non-linear activations, and attention-weight calculations, which the server executes using optimized linear algebra libraries and, in some cases, hardware acceleration on a graphics processing unit.

During training of the generative AI model, a training subsystem, which may be separate from the deployed server, adjusts model parameters by minimizing a loss function such as cross-entropy between predicted token distributions and reference reply sentences. The training subsystem updates model weights by a gradient-based optimization method, such as stochastic gradient descent or an adaptive gradient method. The model may be trained using data augmentation techniques, such as paraphrasing, synonym replacement, or random segment masking, to increase robustness. The deployment server loads the trained model parameters and uses them only for inference.

The server receives response information from the generative AI model, which contains the reply-content candidate. The server decodes token identifiers back to text and stores the reply-content candidate in association with the input information. The server may perform a post-processing step that enforces syntactic completeness, removes undesired tokens, or verifies that the response complies with length and style constraints.

The server constructs primary-judgment prompt sentences for fraud assessment by aggregating transaction-related features. For example, the server generates a primary-judgment prompt sentence such as:
“This is a payment transaction with the following attributes: card_country=JP, amount=30,000 JPY, purchase_time=2026-0130 20:15 JST, ip_country=US, device_type=smartphone, number_of_transactions_last_hour=5, average_amount_last_day=4,000 JPY. Is there a possibility that this payment is fraudulent? Answer only with one of the following: ‘low’, ‘medium’, or ‘high’ risk.”

The server inserts actual feature values into the template. The server builds these features by querying the database for historical records, computing aggregates, and encoding them into textual descriptions. The server may also encode part of the features as auxiliary vectors directly provided to the generative AI model together with the prompt sentence, in order to reduce prompt length and improve computational efficiency.

The server inputs the primary-judgment prompt sentence into the same or a separate generative AI model. In an embodiment, the server uses a unified model that handles both reply generation and fraud risk classification by conditioning behavior on system-level control tokens added to the prompt. In another embodiment, the server uses two specialized models: one for conversational generation and one for fraud scoring. The server receives the primary-judgment result as a short textual output constrained by the allowed labels, for example “medium risk.” The server parses the output and maps it to an internal numerical score. By constraining the allowed outputs and by using a structured template for the prompt sentence, the server reduces parsing errors and increases the reliability of downstream processing.

The server then derives feature information for final judgment by combining the primary-judgment result with more detailed user and transaction history. The server calculates, for example, an anomaly score based on how far the current transaction deviates from a learned distribution of historical transactions for the same user, payment instrument, or geographic region. The server can maintain precomputed statistics, such as standard deviation of typical purchase amounts and typical purchase times, in the database. The server uses specialized data structures, such as indexed tables keyed by user identifier or payment token, to accelerate these lookups and aggregations.

The server constructs a final-judgment prompt sentence, such as:
“You previously classified this transaction as ‘medium’ risk. Additional context: user_usual_country=JP, current_ip_country=US, usual_amount_range=1,000-5,000 JPY, current_amount=30,000 JPY, time_since_last_transaction=5 minutes, number_of_recent_failed_attempts=3. Considering all this information, provide a final judgment as exactly one of ‘safe’, ‘suspicious’, or ‘review required’ and give a one-sentence reason.”

The server controls the prompt content to include both intermediate results and refined features. This staged use of the generative AI model allows the server to offload complex reasoning steps to the model while keeping the server's rule set compact. The server thus transforms what would otherwise be multiple disjoint evaluation processes into a coordinated multi-stage inference sequence, improving computational efficiency and reducing latency by reusing previously computed results.

The server inputs the final-judgment prompt sentence into the generative AI model and obtains the final-judgment result. The server parses the label and reason, and maps them into standardized codes such as 0 for safe, 1 for suspicious, and 2 for review required. The server generates examination-result information that includes at least this label and, optionally, the textual explanation. The server stores this data into the database with explicit foreign-key relationships to transaction records and message records, so that subsequent audits and model retraining can reconstruct the full decision context.

The server outputs the examination-result information to the terminal via an encrypted communication protocol, such as a secure transport protocol. The terminal receives the data and updates its display to show a concise message to the user, such as “This payment is safe,” “This payment may be fraudulent,” or “Additional verification is required.” The terminal may further display a portion of the reply-content candidate for the user to review, and the user can correct or approve the content through a user interface.

The server causes the display apparatus to present the reply-content candidate to the user, who may be, for example, an operator or a staff member. The user reviews the generated text and performs a correction operation by editing the text through an input device. The server receives the correction operation, updates the stored reply-content candidate, and optionally uses the corrected text as feedback data for future fine-tuning of the generative AI model. This feedback pathway allows the server to improve long-term accuracy and alignment of generated replies with real-world communication requirements.

The server's configuration provides several technical effects beyond mere automation of human tasks. By centralizing and formalizing prompt construction, the server reduces variability and ambiguity in model interactions, which leads to more stable and predictable outputs. By using a staged primary and final judgment architecture and by reusing intermediate judgments as structured input to subsequent inferences, the server reduces the volume of data that needs to be recomputed and narrows the search space of possible model outputs, which decreases computation time and model resource consumption. The server also improves data management by explicitly linking message content, transaction information, intermediate features, prompt sentences, and model outputs in a unified data schema, which supports efficient querying, auditing, and retraining operations.

The server improves accuracy in fraud detection because the generative AI model is provided with richer contextual features and is guided by carefully constructed prompt sentences that incorporate intermediate judgments and statistical attributes. The model is not merely performing a direct mapping from raw transaction features to a fraud label; instead, it performs a reasoning process over a structured description that encodes both raw features and derived risk indicators. This reduces false positives and false negatives compared to heuristic-based or single-stage models.

The server also improves processing speed. In one embodiment, the server caches embeddings or partial feature computations for repeated users or devices, and reuses them across transactions. The server may pre-generate portions of prompt sentences and maintain them as templates, inserting only variable elements at runtime. The server can also batch multiple model inferences and execute them concurrently on hardware accelerators, using lower-precision arithmetic (for example, 16-bit floating point) where appropriate to reduce computation time without degrading the quality of text outputs.

The server uses a non-conventional processing order and data flow compared to typical human workflows. Rather than first completing a fraud decision and then generating message content, or vice versa, the server leverages the generative AI model both for communication generation and for risk assessment using a shared or coordinated environment. The server applies internal rules that determine when a primary-judgment prompt is constructed, when a final-judgment prompt is constructed, and how these prompts include specific feature sets. These rules do not simply encode human-written policies, but encode technical constraints oriented toward model performance, latency, and resource usage, such as limiting prompt length, avoiding redundant information, and aligning model outputs with discrete labels for machine parsing.

In an alternative embodiment, the server uses an ensemble of models: a first model specialized in language understanding to extract intents and sentiment from message content, a second model specialized in sequence modeling of transaction streams, and a third generative model that fuses textual and numerical features to output both reply drafts and risk labels. The server coordinates these models by passing intermediate embeddings through shared memory structures and by converting numerical sequence outputs into natural language descriptions used in prompt sentences. This architecture further demonstrates that the system focuses on internal computer processing improvements, such as modular inference flows and feature sharing, rather than on abstract business logic.

In another variation, the server employs an adaptive thresholding mechanism that adjusts risk-score thresholds based on system load, time of day, or historical performance. The server can record the distribution of primary-judgment and final-judgment outputs over time and automatically tune the mapping from model outputs to decision codes to maintain a target false-positive rate or a target detection rate. This closed-loop mechanism improves the computer's overall performance in real-time decision environments, where network latency and throughput constraints are significant.

Because the server integrates prompt construction, feature extraction, model inference, and decision mapping in a unified software and hardware configuration, the invention provides a specific technical improvement to computer operation. The server transforms raw message content and transaction information into standardized, machine-readable decision artifacts through non-conventional sequences of data transformations and generative modeling, and thereby achieves higher processing efficiency, improved accuracy, and better resource utilization than generic, non-specialized systems that separately handle communication support and fraud detection or that invoke generative AI models with ad hoc, manually authored prompts.

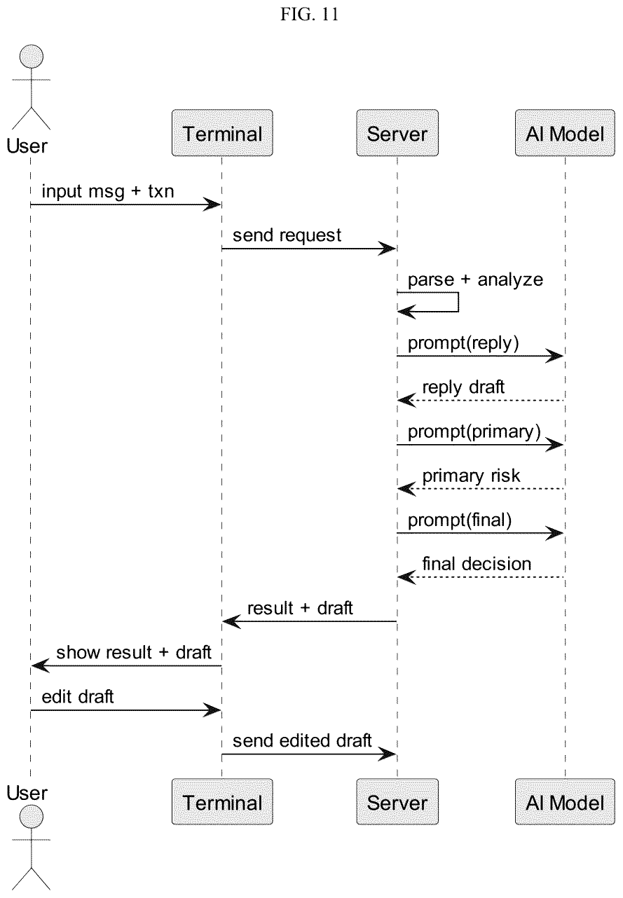

The following describes the processing flow using FIG. 11.

### Step 1:

The user operates the terminal to input message content and transaction information. The user enters, via a graphical user interface on the terminal, text for the message content (such as a note or inquiry) and transaction-related values such as a payment instrument identifier, a transaction amount, a currency, and a desired execution time. The terminal receives these user inputs as raw strings and numeric values (input) and organizes them into internal data fields, for example, message_text, card_token, amount, currency, and timestamp (output). The terminal stores this structured data in memory as a single request object.

### Step 2:

The terminal prepares and transmits a request to the server. The terminal takes the structured request object (input) and serializes it into a data format such as a text-based representation with key-value pairs. The terminal then adds metadata such as device_type, ip_address, and user_id, and encrypts the entire request using a secure transport protocol. As a result of this processing, the terminal outputs an encrypted network message that includes the serialized message content and transaction information, and sends this encrypted message through the communication interface to the server.

### Step 3:

The server receives and parses the incoming request. The server accepts the encrypted network message (input) through a network interface and uses a transport-layer security module to decrypt the message, reconstructing the original serialized data. The server then parses the serialized data to extract fields such as message_text, card_token, amount, currency, timestamp, ip_address, and device_type. The server outputs an internal data structure stored in memory, for example a record or object containing all extracted fields in a normalized format.

### Step 4:

The server performs text analysis on the message content. The server takes the message_text field from the internal data structure (input) and applies a natural language processing pipeline: tokenization, normalization (for example, lower-casing), optional stop-word filtering, and part-of-speech tagging. The server then computes semantic features, such as an embedding vector produced by a pretrained encoder network or by averaging word vectors. The server may also estimate a sentiment score and a message category (for example, inquiry, complaint, or notification) using a classifier model. The server outputs analysis result information for the text, including tokens, an embedding vector, a sentiment label, and a category label, stored as part of a feature object in memory.

### Step 5:

The server performs structured-data analysis on the transaction information. The server takes fields such as card_token, amount, currency, timestamp, ip_address, and device_type (input) and first normalizes numeric values and time values: for example, converting the timestamp into a unified time zone and scaling the amount into a normalized range. The server queries a transaction history store using the card_token and user_id to retrieve prior transaction records. The server then performs numerical aggregations, such as computing total_amount_last_24 h, number_of_transactions_last_hour, average_amount_last_day, and a geographic distance between current ip_address and typical login locations. The server outputs a transaction feature set, including normalized continuous features, categorical encodings, and historical aggregates, as part of the feature object in memory.

### Step 6:

The server generates a first prompt sentence for reply-content generation. The server takes the message_text and the text-related analysis result information (input) and selects appropriate template phrases from a prompt-template store based on the category and sentiment. The server then concatenates these template segments with the original message text to construct a prompt sentence such as: “You are generating a polite and reassuring reply. The following is a message from a sender: ‘[message_text]’. Based on this message, create a reply draft that clearly addresses the sender's concerns and increases the sender's sense of reassurance and trust. Output only the reply text.” The server outputs a fully formed first prompt sentence as a text string to be used as input to a generative AI model.

### Step 7:

The server invokes the generative AI model to obtain a reply-content candidate. The server takes the first prompt sentence and, optionally, semantic features of the message (input) and encodes the prompt sentence into token identifiers using a tokenizer associated with the generative AI model. The server constructs an input tensor from these token identifiers and forwards this tensor to a model inference engine. The generative AI model, implemented as a transformer-based neural network, performs matrix multiplications, attention-weight calculations, and non-linear activations to generate a sequence of output token probabilities. The server then decodes the most probable token sequence into a natural language text. The server outputs this decoded text as response information representing the reply-content candidate and stores it together with the input information in memory.

### Step 8:

The server associates the reply-content candidate with the transaction information as screening input information. The server takes the reply-content candidate and the transaction feature set (input) and constructs a combined screening object that includes both the generated reply text and the transaction-related features. The server may also add internal identifiers such as transaction id and user_id to the screening object. The server outputs the screening input information, which is a structured data object tying together communication and transaction context for subsequent fraud assessment.

### Step 9:

The server generates a primary-judgment prompt sentence for fraud assessment. The server takes the screening input information, in particular the transaction feature set (input), and selects a fraud-assessment prompt template from a template store. The server fills in placeholders in the template with concrete feature values, for example generating a prompt sentence such as: “This is a payment transaction with the following attributes: card_country=JP, amount=30,000 JPY, purchase_time=2026-0130 20:15 JST, ip_country=US, device_type=smartphone, number_of_transactions_last_hour=5, average_amount_last_day=4,000 JPY. Is there a possibility that this payment is fraudulent? Answer only with one of the following: ‘low’, ‘medium’, or ‘high’ risk.” The server outputs this primary-judgment prompt sentence as text to be supplied to the generative AI model.

### Step 10:

The server invokes the generative AI model to obtain a primary-judgment result. The server takes the primary-judgment prompt sentence (input) and encodes it into tokens and tensors, similar to Step 7. The generative AI model processes this tensor through its neural network layers, calculating attention across tokens and computing an output distribution over possible labels or words. The server constrains decoding to the set {“low”, “medium”, “high”} by applying a decoding rule that restricts valid output tokens. The server decodes the model output and obtains a label such as “medium” for risk level. The server outputs the primary-judgment result as both a textual label and a mapped numerical score, stored in the screening object.

### Step 11:

The server derives feature information for final judgment. The server takes the primary-judgment result and the transaction feature set (input) and performs additional computations: for example, computing a combined risk_score by weighting the primary risk score with anomaly metrics derived from transaction history, and generating flags such as high_amount_flag or cross_border_flag. The server aggregates these indicators into a feature information object that summarizes characteristics of the transaction, including both raw features and derived indicators. The server outputs this feature information and updates the screening object to include it.

### Step 12:

The server generates a final-judgment prompt sentence. The server takes the feature information and the primary-judgment result (input) and selects a final-assessment prompt template. The server replaces template variables with actual values, generating a prompt sentence such as: “You previously classified this transaction as ‘medium’ risk. Additional context: user_usual_country=JP, current_ip_country=US, usual_amount_range=1,000-5,000 JPY, current_amount=30,000 JPY, time_since_last_transaction=5 minutes, number_of_recent_failed_attempts=3. Considering all this information, provide a final judgment as exactly one of ‘safe’, ‘suspicious’, or ‘review required’ and give a one-sentence reason.” The server outputs this final-judgment prompt sentence as text ready to be input to the generative AI model.

### Step 13:

The server invokes the generative AI model to obtain a final-judgment result. The server takes the final-judgment prompt sentence (input), encodes it into tokens and tensors, and passes it to the generative AI model. The model processes the input using its attention layers and feedforward layers and generates an output sequence that contains a label and a short explanation. The server decodes this sequence into text, then parses the label portion, ensuring that it matches one of the allowed values: “safe”, “suspicious”, or “review required.” The server outputs the final-judgment result, including the label and the explanation, and stores it with the associated transaction id in memory.

### Step 14:

The server generates examination-result information. The server takes the final-judgment result (input) and maps the textual label into an internal decision code, such as 0 for safe, 1 for suspicious, and 2 for review required. The server composes examination-result information that includes the decision code, the textual label, the explanation, and identifiers such as transaction id and user_id. The server may also attach the primary-judgment result and key features for auditing. The server outputs this examination-result information in a structured format and records it in a persistent storage system.

### Step 15:

The server transmits examination-result information to the terminal and prepares the reply-content candidate for display. The server takes the examination-result information and the reply-content candidate (input) and serializes them into a response message. The server encrypts this message using a secure transport protocol and sends it via the network interface to the terminal. In parallel or in a related operation, the server causes a display apparatus to present the reply-content candidate to the user, for example on a management console. The server outputs an encrypted response over the network and a display update request to the display apparatus.

### Step 16:

The terminal receives and displays the examination result, and the user edits the reply-content candidate. The terminal takes the encrypted response from the server (input), decrypts it, and parses the examination-result information and the reply-content candidate. The terminal then updates the user interface to display, on the terminal's display device, a message indicating the decision (for example, “safe”, “suspicious”, or “review required”) and the generated reply-content candidate. The user reviews the reply-content candidate and, if necessary, performs a correction operation by editing the text through an input control. The terminal collects the corrected text (output) and prepares it as an updated reply-content candidate that can be sent back to the server for storage or further processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In electronic payment environments, conventional fraud detection technologies typically rely on static rule engines or conventional machine learning models that are trained on fixed feature sets and updated infrequently. Such approaches suffer from several technical deficiencies in terms of computer technology. First, static rules and fixed models lack adaptability to rapidly evolving fraud patterns, resulting in high false positives and false negatives, which in turn cause inefficient use of computational resources due to repeated manual review and reprocessing of similar transactions. Second, many existing systems process transaction data and fraud evaluation in loosely coupled, batch-oriented pipelines, where the generation of risk scores is not tightly integrated with real-time user interaction and feedback. This loose coupling leads to additional latency, redundant database accesses, and increased communication overhead between separate components, degrading the responsiveness and throughput of the overall computer system. Third, some systems simply invoke a machine learning model as a black box without structured, context-rich input, leading to suboptimal model usage, because important behavioral context is not encoded in a form that the model can effectively process, thereby wasting computation and model capacity. Furthermore, conventional systems rarely incorporate user feedback (such as whether a user confirms or rejects a suspicious transaction) as structured, machine-usable labels in an automated way. As a result, the computer system cannot efficiently update its internal parameters, thresholds, or input formatting to improve detection accuracy over time, and must instead rely on manual data preparation and offline retraining workflows that consume additional processing cycles and storage bandwidth. This absence of an integrated feedback loop prevents the system from optimizing the configuration of prompts or queries used to interface with advanced models, such as generative AI models, and prevents the system from dynamically tailoring fraud detection behavior to the current data distribution.

In addition, when generative AI models are used for fraud detection in a naive manner, prompt sentences are often handcrafted or static, lacking systematic incorporation of user behavioral statistics, external risk indicators, and multi-stage decision structures. This leads to inconsistent inference results and inefficient use of computational resources, because prompts may be verbose, incomplete, or misaligned with the model's strengths. Moreover, many systems do not support hierarchical decisions in which an initial, low-cost evaluation is followed by a more detailed analysis only when necessary. Consequently, computational load on the AI inference infrastructure increases unnecessarily, causing higher latency and lower throughput for all transactions.

Accordingly, there is a need for improved computer-implemented techniques that (i) automatically construct structured, context-rich prompt sentences based on normalized transaction data and computed behavioral statistics, (ii) perform hierarchical, multi-stage fraud analysis using a generative AI model, (iii) integrate real-time user feedback as labeled data into the processing pipeline, and (iv) dynamically adjust prompt configuration and model output requirements based on accumulated feedback, thereby improving the accuracy, efficiency, and adaptability of fraud detection on a computer system. The technical problem to be solved is to enhance the functioning of the computer system itself-specifically, to reduce unnecessary computations, to lower latency of fraud evaluation, to increase the precision and recall of fraud detection, and to provide a self-improving, feedback-driven interaction between transaction processing components, storage components, and a generative AI model.

The specific processing by the specific processing unit 290 of the data processing device 12 in Application Example 1 is realized by the following means.

The present invention provides a server comprising a processor configured to receive, via a communication interface, transaction information including payment information from a user terminal, normalize the transaction information, store the normalized transaction information together with a transaction identifier in a storage device, and retrieve past transaction history associated with a user identifier included in the transaction information from the storage device so as to calculate statistical feature information representing behavioral characteristics of the user; to generate a prompt sentence for input to a generative AI model based on the statistical feature information and the transaction information, to transmit inquiry data including the prompt sentence to the generative AI model, and to acquire, from the generative AI model, numerical information or classification information indicating a probability of fraud; to compare the acquired numerical information or classification information with a predetermined reference value or determination condition, to determine whether the transaction is a transaction having a possibility of fraud, and to record, in the storage device, transaction management information including a fraud-suspected flag and examination result information; to generate notification data to be transmitted to the user terminal based on at least one of the fraud-suspected flag and the examination result information, the notification data including transaction content and an option for confirming validity of the transaction, and to transmit the notification data to the user terminal; to receive response information from the user terminal indicating a user selection with respect to the option, to update a settlement state of the transaction based on the response information, and to accumulate the settlement state of the transaction as teacher data for machine learning; and to update at least one of a structure of the prompt sentence and an output request condition for the generative AI model based on the accumulated teacher data and to dynamically adjust fraud determination processing in order to improve fraud detection accuracy. This enables the computer system to more efficiently utilize processing and storage resources by constructing context-rich prompt sentences tailored to user behavior, to perform hierarchical and real-time fraud evaluation with reduced latency, to integrate user feedback as labeled data without manual intervention, and to automatically refine prompt configuration and decision thresholds over time, thereby improving the technical performance and adaptability of the fraud detection platform.

The term “transaction information” refers to data representing an individual electronic transaction, including at least a user identifier, payment information such as an amount and a currency, a transaction time, and optionally information such as a merchant identifier, a location, and a device identifier.

The term “payment information” refers to a subset of transaction information that specifies monetary aspects of a transaction, including at least a transaction amount and a currency, and optionally details such as a payment method type and a payment instrument identifier.

The term “user terminal” refers to an information processing device operated by a user, such as a mobile device, a personal computer, or another computing apparatus, that is configured to transmit transaction information and response information to a server and to receive notification data from the server.

The term “communication network” refers to a wired or wireless communication infrastructure, including at least one of the Internet, a mobile communication network, a local area network, and a wide area network, that enables data exchange between the user terminal and the server.

The term “server” refers to an information processing apparatus including at least one processor and at least one storage device, which is configured to execute programs for receiving, storing, analyzing, and managing transaction-related data.

The term “processor” refers to a hardware computation unit or a set of computation units, such as a central processing unit or another programmable processing device, that executes instructions to perform operations including data reception, analysis, comparison, generation, and storage.

The term “storage device” refers to a hardware component or a combination of components that provide non-transitory data storage, such as a memory device, a magnetic storage device, or a solid-state storage device, used to retain transaction information, transaction management information, and teacher data.

The term “normalize the transaction information” refers to converting raw transaction information into a standardized internal format, including at least adjusting time information to a unified time standard, converting location or currency information to a consistent representation, and validating or correcting data fields for subsequent processing.

The term “transaction identifier” refers to data that uniquely identifies a single transaction within the system, such as a unique alphanumeric code, which is stored in association with the corresponding transaction information.

The term “past transaction history” refers to stored transaction information for transactions that were previously processed for the same user identifier, and that is used for analysis of user behavior.

The term “user identifier” refers to data representing an individual user or an account, such as an account number or another unique code, which is used to associate multiple transactions with the same user.

The term “statistical feature information” refers to numerical or categorical values derived from past transaction history, including at least aggregated measures such as frequency, ranges, averages, or distributions of transaction attributes that represent behavioral characteristics of the user.

The term “behavioral characteristics of the user” refers to patterns in transaction behavior associated with a user, including typical transaction amounts, usual transaction locations, typical times of day for transactions, and other statistically inferred tendencies.

The term “generative AI model” refers to a model based on artificial intelligence techniques, such as a neural network model, that is configured to generate output information, including at least numerical information or classification information, in response to input data in the form of a prompt sentence or other query structure.

The term “prompt sentence” refers to a text string or structured natural language description prepared for input to a generative AI model, the text string including at least transaction information and statistical feature information and optionally external risk information, and designed to cause the generative AI model to output information related to fraud risk.

The term “inquiry data” refers to data transmitted from the server to the generative AI model, the data including at least the prompt sentence and optionally one or more parameters indicating desired output format or model behavior.

The term “numerical information indicating a probability of fraud” refers to a value or set of values output by the generative AI model that quantitatively represents a likelihood that a given transaction is fraudulent, such as a score between two defined bounds.

The term “classification information indicating a probability of fraud” refers to categorical output from the generative AI model that indicates a fraud-related classification of a transaction, such as labels representing different levels of risk or different fraud-related categories.

The term “predetermined reference value” refers to a threshold value or set of threshold values stored in the system and used as a comparison basis to determine whether numerical information from the generative AI model indicates a possibility of fraud.

The term “determination condition” refers to a rule or set of rules applied to numerical information or classification information to decide whether a given transaction should be treated as having a possibility of fraud.

The term “transaction having a possibility of fraud” refers to a transaction for which the numerical information or classification information output from the generative AI model, when evaluated according to the predetermined reference value or determination condition, meets criteria indicating that the transaction may be fraudulent.

The term “transaction management information” refers to a data structure stored in the storage device that manages the state and evaluation results of a transaction, including at least a transaction identifier, a fraud-suspected flag, and examination result information.

The term “fraud-suspected flag” refers to an indicator field within the transaction management information that represents whether a transaction is currently considered to have a possibility of fraud based on evaluation by the generative AI model and associated rules.

The term “examination result information” refers to data representing an outcome of fraud evaluation, including at least an intermediate or final determination status, such as a label or score indicating whether a transaction is considered fraudulent, suspicious, or legitimate.

The term “notification data” refers to data generated by the server for transmission to the user terminal, the data including at least transaction content and an option for confirming validity of the transaction.

The term “transaction content” refers to information presented to the user regarding a specific transaction, including at least an amount, a time, and optionally a location, a merchant identifier, and a brief description of the transaction.

The term “option for confirming validity of the transaction” refers to one or more selectable choices presented to the user through the user terminal, such as an option to approve a transaction and an option to report a transaction as not recognized or fraudulent.

The term “response information” refers to data transmitted from the user terminal to the server indicating a user selection with respect to the option for confirming validity of the transaction, and optionally including additional user input.

The term “settlement state of the transaction” refers to information indicating a processing status of the transaction within the payment system, including at least whether the transaction is approved, held, canceled, or blocked.

The term “teacher data for machine learning” refers to labeled data stored in the storage device and used as training data for machine learning, the labeled data including at least transaction information and associated labels derived from the settlement state of the transaction and user responses.

The term “structure of the prompt sentence” refers to an arrangement and content of elements used to form a prompt sentence, including selection and ordering of fields, phrasing patterns, and inclusion of specific types of contextual information.

The term “output request condition for the generative AI model” refers to one or more parameters or constraints specified by the server regarding the expected format, type, or content of output generated by the generative AI model.

The term “dynamically adjust fraud determination processing” refers to modifying, during operation of the system, at least one of the prompt sentence structure, output request conditions, thresholds, or decision rules based on accumulated teacher data, in order to change how the system evaluates and classifies fraud risk.

The term “first-stage fraud risk information” refers to information representing an initial evaluation of fraud risk for a transaction, obtained by inputting a first prompt sentence to the generative AI model.

The term “first prompt sentence” refers to a prompt sentence designed to cause the generative AI model to output first-stage fraud risk information based primarily on transaction information and statistical feature information.

The term “second prompt sentence” refers to a prompt sentence generated after obtaining first-stage fraud risk information, the prompt sentence including at least the first-stage fraud risk information and external risk information, and used to obtain a final fraud determination result from the generative AI model or another generative AI model.

The term “external risk information” refers to information external to the basic transaction information and user behavior statistics, including at least data related to device characteristics, network characteristics, or other contextual risk indicators.

The term “final fraud determination result” refers to an output from the generative AI model or another generative AI model that represents a final classification or judgment as to whether a transaction is fraudulent, suspicious but likely legitimate, or legitimate.

The term “hierarchically determine the fraud-suspected flag and the examination result information” refers to setting or updating the fraud-suspected flag and examination result information in multiple stages, including at least a stage based on first-stage fraud risk information and a stage based on the final fraud determination result.

The term “real time” refers to a time frame sufficiently short such that fraud risk evaluation and user notification are carried out at or near the time of occurrence of the transaction, before completion of final settlement, and without substantial delay from the perspective of the user and the system.

The term “coordinate generation of the prompt sentence with reception of the transaction information in real time” refers to initiating formation and transmission of the prompt sentence to the generative AI model substantially immediately after transaction information is received, such that fraud evaluation is performed without batch processing delays.

The term “execution permission of the transaction” refers to a decision state indicating whether a transaction is allowed to proceed, is placed on hold, or is blocked, based at least in part on response information received from the user terminal and the results of fraud evaluation.

In one embodiment, a server implements the claimed system using a general-purpose computer platform. The server includes at least one processor, a main memory, a non-transitory storage device, and a network interface. The processor may be implemented by a central processing unit of an x86_64 architecture, for example a multi-core server-grade processor. The main memory may be implemented by a volatile memory device such as a dynamic random access memory module. The storage device may be implemented by a non-volatile device such as a solid-state drive or a magnetic disk device. The network interface may support Ethernet communication and be connected to a communication network such as the Internet.

The server executes an operating system such as a general-purpose server operating system and a set of application programs including a web server component, an application server component, a database management system, and a generative AI inference component. The server may execute a web server program such as an HTTP server that terminates Transport Layer Security connections, and the server may execute an application framework program such as a scripting-language-based web framework. The server may execute a relational database management system such as a structured query language database to store transaction information, transaction management information, and teacher data. The server may execute an AI runtime environment implementing a neural network framework such as a tensor-based computation library to perform inference of a generative AI model.

The terminal is implemented by a client information processing device such as a smartphone, a tablet, or a personal computer. The terminal includes a processor, a memory, a display, an input device, and a wireless or wired communication interface. The terminal executes a client application such as a mobile payment application or a web browser. The terminal transmits transaction information and response information to the server via the communication network and receives notification data from the server.

The user is an operator of the terminal. The user initiates payment operations by providing payment amounts and other information through the terminal. The user receives notifications on the terminal and selects options to approve or reject suspicious transactions.

In one embodiment, the server uses the relational database management system to define structured tables for storing transaction information and transaction management information.

The server structures transaction information as records including fields such as user identifier, transaction identifier, transaction amount, currency, transaction time, location code, merchant code, and device information. The server structures transaction management information as records including fields such as transaction identifier, fraud-suspected flag, numerical risk score, intermediate classification label, final classification label, and examination result information.

The server uses the database to compute statistical feature information representing behavioral characteristics of the user. The server may execute aggregate queries computing, for each user identifier, statistics such as mean and variance of transaction amounts, minimum and maximum transaction amounts, frequencies of transactions per time-of-day window, and distributions over location codes. The server may store such aggregated results in a separate profile table or may compute such statistics on demand for each transaction. The server thereby transforms raw historical transaction data into structured numerical features.

The server uses the statistical feature information and the current transaction information to construct a prompt sentence for input to a generative AI model. The server implements a prompt-generation module that formats the data into a structured natural language template.

For example, the server may generate the following prompt sentence as plain text:
“You are a fraud detection generative AI model.

Analyze the following credit card transaction using the user's historical behavior.

### Transaction:

User ID: 12345
Amount: 1000 USD
Location: France
Time: 2026-0130 10:32:00 UTC

### User Behavior Summary:

Usual locations: Japan
Typical amount range: 10-100 USD
Typical time of day: 18:00-22:00 JST

Output only a JSON-like text with a single field ‘fraud_risk_score’ between 0 and 1.”

In another embodiment, the server uses a multi-stage prompt structure. The server generates a first prompt sentence to obtain a first-stage fraud risk score and a second prompt sentence to obtain a final decision. For example, the server may generate the second prompt sentence as:
“You are a generative AI model that makes final fraud decisions.
First-stage fraud risk score: 0.95

### Transaction and Behavior Data:

User ID: 12345
Current transaction: 1000 USD in France at 2026-0130 10:32:00 UTC
User's usual locations: Japan
User's typical amount: 10-100 USD
User's typical time: 18:00-22:00 JST

Please respond with two fields:
‘decision’: one of [‘fraud’, ‘suspicious_but_likely_legitimate’, ‘legitimate’]
‘reason’: a short explanation.”

The server employs a generative AI model implemented as a neural network, for example a transformer-based language model. The server stores the model parameters in the storage device or in a dedicated model store. The server uses an AI framework to load the model into memory and to execute inference on the processor or on an attached accelerator device such as a graphics processing unit. The generative AI model includes multiple layers such as an embedding layer, a plurality of self-attention layers, feedforward layers, and a final output layer. The embedding layer converts each token of the prompt sentence into a vector. The self-attention layers compute attention weights over all token positions using weight matrices, and the feedforward layers apply non-linear transformations. The final output layer produces a probability distribution over possible next tokens. The server uses the AI framework to iteratively generate tokens until the model outputs a completed response, and the server then parses the response.

In one training embodiment, the generative AI model is pre-trained on a large corpus of general text and optionally fine-tuned on domain-specific transaction data. The server or an offline training system minimizes a loss function such as a cross-entropy loss over target tokens. The training algorithm updates the model's weight parameters using a gradient-based optimizer such as a stochastic gradient descent variant. The server or the training system may perform data augmentation techniques such as perturbing numeric values within realistic bounds or synthesizing additional transaction narratives to improve model robustness. The server may obtain a model that is capable of encoding and exploiting relationships between transaction context, user behavior patterns, and fraud likelihood.

The server uses non-conventional feature engineering combined with prompt formatting to improve the technical performance of the generative AI model. The server does not simply pass raw transaction values as a flat list; instead, the server orders and groups fields in the prompt sentence according to a predetermined structure, such as “current transaction information,” “historical behavior summary,” and “external risk indicators.” The server computes categorical descriptors such as “unusual country” or “amount significantly higher than mean” by applying comparison operations and threshold checks on the statistical feature information. The server then encodes these descriptors into the prompt sentence. This structured encoding allows the generative AI model to converge more quickly to a stable output and reduces the number of tokens needed, which in turn decreases inference time and memory usage.

The server implements a fraud-evaluation module that applies explicit rules to numerical information or classification information returned from the generative AI model. For numerical fraud risk scores, the server compares the score against a first threshold for initial suspicion and a second threshold for escalation. For classification outputs, the server maps labels to fraud-suspected flag states according to a deterministic mapping table. The server thereby converts potentially variable textual outputs into stable, machine-usable flags and examination result information. This explicit mapping reduces ambiguity and eliminates the need for manual interpretation of free-text AI outputs.

The server implements a notification-generation module that constructs notification data for the user terminal. The server extracts key transaction content such as the amount, currency, approximate location, and time from the stored transaction information. The server composes explanatory text including a brief risk summary, such as “Unusual country for your past usage,” derived from statistical feature information and the AI output. The server embeds a transaction identifier or a secure token into a link or deep link for the terminal application.

The server then transmits the notification data via a push notification service or another communication channel.

The terminal receives the notification and presents it to the user using the display and an operating system notification API. The terminal launches the client application when the user selects the notification. The terminal requests detailed transaction information from the server using the embedded identifier. The server returns a detailed record, and the terminal renders a screen with options such as “Approve this transaction” and “This is not my transaction.” The user selects one option, and the terminal transmits response information back to the server.

The server records the response information and updates the settlement state of the transaction. For example, the server sets the settlement state to “user_approved” or “user_reported_fraud.” The server stores this state in association with the transaction identifier. The server also marks the combination of transaction features, AI risk scores, and the user-confirmed state as teacher data. The server aggregates such teacher data across many transactions and users. This aggregation forms a labeled dataset where each transaction is tagged with an outcome label representing the user's ground-truth assessment and the subsequent resolution of the transaction.

The server uses the teacher data to improve its internal parameters and processing. In one embodiment, the server updates threshold values used for mapping AI scores to fraud-suspected flags by minimizing observed misclassification rates over the teacher data. The server may use a search algorithm to adjust thresholds to reduce false positives for legitimate transactions while maintaining or improving detection of fraudulent transactions. In another embodiment, the server uses the teacher data to re-rank or re-weight feature importance when constructing prompt sentences. For example, if teacher data indicates that time-of-day deviations consistently correlate with fraud for a particular user segment, the server increases the level of detail and prominence of time-of-day features within the prompt sentence.

The server also uses teacher data to perform fine-tuning of the generative AI model. The server or an associated training subsystem selects prompt-response pairs from the teacher data, where the prompt sentences are constructed from transaction information and statistical feature information, and the target outputs are desired scores or labels reflecting user-confirmed outcomes. The training subsystem computes a loss function such as a mean squared error loss for numeric outputs or a cross-entropy loss for classification labels. The training subsystem updates the model's weights via backpropagation, adjusting internal attention patterns and feedforward weights. This adjustment allows the model to place more emphasis on features that empirically correlate with fraud in the deployed environment.

The server thereby improves computer technology in several technical aspects. By normalizing transaction information and computing statistical feature information in advance of generative AI inference, the server reduces redundant pre-processing inside the AI model and ensures that the prompt sentence has a compact and information-dense representation.

This reduces token length and accelerates inference, which improves overall processing throughput. By implementing a two-stage evaluation with a first-stage prompt and a second-stage prompt, the server performs inexpensive coarse screening before invoking more complex analysis. The server may choose not to issue a second-stage prompt for low-risk transactions, reducing the number of costly AI calls and lowering CPU and memory usage on the AI inference subsystem.

The server further improves data management by using a structured schema for transaction management information. The server maintains consistency of fraud-suspected flags, risk scores, and final labels in a normalized database design. This structure allows efficient indexing and query execution for downstream tasks such as audit reporting, model evaluation, and threshold tuning. The use of explicit flags and result fields avoids repeated recomputation of AI inferences on historical transactions, saving computation time and storage bandwidth.

The server achieves a reduction in communication load by coordinating generation of prompt sentences with reception of transaction information and by performing fraud evaluation in real time. Because the server quickly determines whether a transaction is likely safe or suspicious, the server can avoid transmitting unnecessary detailed notifications or additional data for clearly legitimate transactions. Only transactions that meet suspicion criteria trigger full notification flows and user interaction, thereby reducing network traffic between server and terminal and between server and external services.

The server uses non-traditional processing logic that differs from simple human rule automation. The server dynamically adjusts the structure and content of the prompt sentence based on accumulated teacher data. For example, the server may alter the ordering of sections, the granularity of featured statistics, and the inclusion of explanatory phrases that were empirically associated with more stable and accurate model responses. This dynamic prompt adaptation is not a direct representation of a static human rule but is derived from machine-evaluated performance metrics over large datasets. The generative AI model itself uses a high-dimensional weight space and multi-head self-attention mechanisms that cannot be manually simulated by a human reviewer at scale. Thus, the combination of structured pre-processing, dynamic prompt configuration, and neural inference provides a technical approach that is distinct from human pattern recognition.

In alternative embodiments, the server may use different neural network architectures, such as recurrent neural networks, convolutional sequence models, or hybrid models combining transformer layers with other modules. The server may also use different loss functions during training, such as focal loss to handle class imbalance between fraudulent and legitimate transactions. The server may apply regularization techniques such as dropout or weight decay to improve generalization. The server may deploy multiple generative AI models specialized for different transaction types, such as card-present transactions and card-not-present transactions, and may select among these models based on transaction attributes.

In still another embodiment, the server may incorporate external risk signals such as device fingerprint scores, IP address reputation scores, and velocity checks into the statistical feature information and prompt sentences. The server may define a risk-aggregation module that interprets external scores using fixed transformation functions to convert them into normalized risk indicators. The server injects these normalized indicators into the prompt sentences as separate sections, such as “External risk indicators: device is new; IP address country matches transaction country; high login velocity in last hour.” This explicit structuring improves the model's ability to correlate external signals with fraud outcomes and thereby enhances accuracy.

Because the server integrates data normalization, behavioral profiling, structured prompt generation, hierarchical AI inference, explicit rule-based post-processing, user feedback integration, and adaptive model and prompt refinement within a single coherent architecture, the system as a whole improves computational efficiency, reduces latency, and reduces error rates relative to conventional fraud detection systems. The server uses specific data structures, algorithms, and neural processing steps to achieve these improvements, and does not merely automate a human process but provides an enhanced computational mechanism for fraud risk evaluation and transaction control.

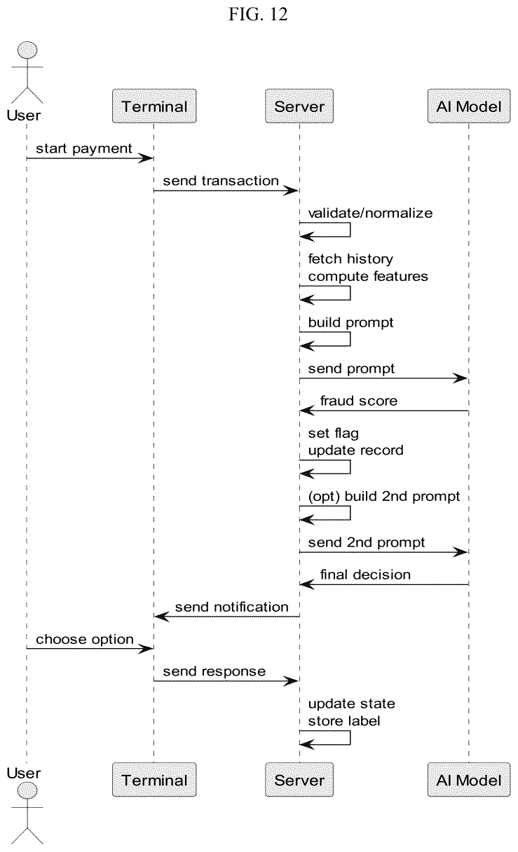

The following describes the processing flow using FIG. 12.

### Step 1:

The user initiates a payment on the terminal by selecting a payment function in an application and entering at least an amount and a payment target.

The terminal receives input values such as user identifier, amount, currency, time, and location information from the user and from device sensors or the operating system.

The terminal generates a transaction information object as output, including the user identifier, amount, currency, local timestamp, location code, merchant information, and a temporary client-side transaction identifier.

### Step 2:

The terminal sends the transaction information to the server via a secure communication channel.

The terminal takes the transaction information object as input and serializes it into a structured message, for example a text-based representation with labeled fields.

The terminal attaches authentication data such as a session token, and outputs an encrypted request over a communication network to an application interface of the server.

### Step 3:

The server receives the transaction information from the terminal and performs validation and normalization.

The server takes the structured transaction information as input and checks the presence and format of fields such as user identifier, amount, and currency; the server also converts the timestamp to a unified time standard and maps the raw location data to a standardized location code.

The server outputs a normalized transaction record that includes a newly generated server-side transaction identifier, the normalized time, normalized location, and validated payment information.

### Step 4:

The server stores the normalized transaction record in a storage device and links it to the corresponding user profile.

The server uses the normalized transaction record as input and writes its fields into a transaction table, generating indexes on fields such as user identifier and transaction identifier.

The server outputs a persistent transaction entry and an internal reference handle that can be used to retrieve this transaction in subsequent processing.

### Step 5:

The server retrieves past transaction history associated with the same user identifier to compute statistical feature information.

The server takes the user identifier and possibly context fields such as currency or transaction type as input, and executes aggregate queries over stored transaction records, computing statistics such as mean, minimum, maximum, standard deviation of amounts, frequency distribution over locations, and count per time-of-day buckets.

The server outputs statistical feature information that numerically represents behavioral characteristics of the user, such as typical amount range, usual locations, and usual transaction times.

### Step 6:

The server generates a prompt sentence for a generative AI model using the current transaction record and the statistical feature information.

The server takes the normalized transaction record and the statistical feature information as input and fills a predetermined textual template, ordering elements into sections such as “Transaction,” “User behavior summary,” and “External indicators.”

The server outputs a structured prompt sentence, for example:
“You are a fraud detection generative AI model.

Analyze the following credit card transaction using the user's historical behavior.

### Transaction:

User ID: 12345
Amount: 1000 USD
Location: France
Time: 2026-0130 10:32:00 UTC

### User Behavior Summary:

Usual locations: Japan
Typical amount range: 10-100 USD
Typical time of day: 18:00-22:00 JST

Output only a text with a single field ‘fraud_risk_score’ between 0 and 1.”

### Step 7:

The server sends the prompt sentence to the generative AI model and obtains a first-stage fraud risk score.

The server takes the prompt sentence as input and passes it through an AI inference interface, which tokenizes the text and feeds the tokens to a transformer-based neural network executing on a processor or accelerator.

The server receives as output a text response containing a numeric fraud risk score, and the server parses this response to extract a numerical value, for example 0.95, as the first-stage fraud risk information.

### Step 8:

The server evaluates the first-stage fraud risk score against predetermined thresholds and updates transaction management information.

The server uses the numeric fraud risk score and preset reference values as input, performs comparison operations such as score≥threshold, and determines whether to set a fraud-suspected flag to true or false.

The server outputs an updated transaction management record in the storage device that includes the fraud-suspected flag, the recorded fraud risk score, and a preliminary examination result label such as “low risk,” “medium risk,” or “high risk.”

### Step 9:

The server optionally generates a second-stage prompt sentence for a final decision using the first-stage result and additional risk indicators.

The server takes as input the first-stage fraud risk score, the fraud-suspected flag, the original transaction record, the statistical feature information, and any external risk information such as device novelty or IP reputation.

The server generates as output a second prompt sentence, for example:
“You are a generative AI model that makes final fraud decisions.
First-stage fraud risk score: 0.95

### Transaction and Behavior Data:

User ID: 12345
Current transaction: 1000 USD in France at 2026-0130 10:32:00 UTC
User's usual locations: Japan
User's typical amount: 10-100 USD
User's typical time: 18:00-22:00 JST

Please respond with two fields:
‘decision’: one of [‘fraud’, ‘suspicious_but_likely_legitimate’, ‘legitimate’]
‘reason’: a short explanation.”

### Step 10:

The server sends the second-stage prompt sentence to a generative AI model and obtains a final fraud determination result.

The server takes the second prompt sentence as input and performs another AI inference call, possibly to the same or a different neural network instance, which processes the input tokens through its attention layers and generates output tokens describing a decision and a reason.

The server outputs a final fraud determination label such as “fraud” or “legitimate” and an associated explanation string, and records these in the transaction management information.

### Step 11:

The server determines whether to notify the user based on the fraud-suspected flag and the final fraud determination result.

The server uses the fraud-suspected flag, the fraud risk score, and the final label as input, applies decision rules such as notifying only if the score exceeds a notification threshold or if the label is “fraud” or “suspicious_but_likely_legitimate,” and selects a notification type and urgency level.

The server outputs a notification decision indicating whether notification is required and, if so, which notification channel and template should be used.

### Step 12:

The server generates notification data containing transaction content and confirmation options and sends it to the terminal.

The server takes as input the notification decision, the transaction record, and the transaction identifier, and composes human-readable text summarizing the amount, location, time, and risk indication, along with options such as “Approve” and “Report as not recognized.”

The server outputs a notification payload that includes the transaction content, a secure reference to the transaction identifier, and the confirmation options, and transmits this payload through a push notification or similar mechanism to the terminal.

### Step 13:

The terminal receives the notification data and presents it to the user.

The terminal takes the notification payload as input, invokes the operating system notification interface, and displays a notification message on the display, showing at least the amount, approximate location, and a short message about unusual activity.

The terminal outputs a user interface state in which the user can tap the notification to open a detailed confirmation screen in the client application.

### Step 14:

The user reviews the transaction details on the terminal and selects an option indicating approval or rejection.

The terminal displays a detailed screen using the transaction reference from the notification as input, requests detailed transaction information from the server if needed, and shows the full transaction content, including merchant information and time.

The user outputs an action by pressing an interface element such as “This is my transaction” or “I do not recognize this transaction,” which the terminal records as a decision value.

### Step 15:

The terminal sends response information including the user's decision back to the server.

The terminal takes the decision value, the transaction identifier, and authentication data as input, constructs a structured response message, and transmits it to a confirmation endpoint on the server via the communication network.

The terminal outputs a confirmation request carrying the user's approval or rejection, which the server receives for further processing.

### Step 16:

The server updates the settlement state of the transaction based on the response information and stores teacher data for machine learning.

The server uses the response information, the existing transaction management record, and internal settlement rules as input, changes the settlement state field to a value such as “user_approved” or “user_reported_fraud,” and may trigger downstream payment actions such as releasing or blocking the transaction.

The server outputs updated transaction management information and also records a teacher data entry that includes the transaction features, AI scores, AI labels, and the user-confirmed outcome as a supervised label.

### Step 17:

The server periodically analyzes accumulated teacher data to adjust thresholds and prompt configuration.

The server takes a collection of teacher data records as input, computes error metrics such as false positive rate and false negative rate for different threshold settings and prompt structures, and runs optimization routines that search for parameter values minimizing misclassifications while maintaining desired coverage.

The server outputs updated reference values for thresholds, updated mapping rules for AI output to flags, and revised prompt templates that adjust the ordering and emphasis of features in the prompt sentence.

### Step 18:

The server optionally fine-tunes the generative AI model using the teacher data to improve fraud detection accuracy.

The server or an associated training subsystem uses prompt-target pairs from the teacher data as input, defines a loss function such as cross-entropy for classification or mean squared error for risk scores, and performs gradient-based updates of the model weights using training algorithms.

The server outputs an updated generative AI model with recalibrated parameters that reflect observed fraud patterns in the deployed environment, and then deploys this model for future inference calls in the described fraud detection flow.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional computer-implemented review systems, a computing device typically applies a single-stage statistical or rule-based classifier directly to input data such as images or text and outputs a binary decision (for example, normal or abnormal). Such architectures suffer from multiple technical drawbacks. First, a single-stage model that is trained to directly output final decisions often requires large computational resources and extensive training data to achieve acceptable accuracy, causing high processing latency and limiting throughput on a shared server. Second, when the model output is directly exposed to a user interface, the system often lacks a mechanism to generate structured explanatory information that is consistent with internal numerical indicators such as anomaly scores. This mismatch leads to instability in the output, difficulty in debugging, and reduced reliability of automated decision making. Third, conventional systems do not effectively utilize prompt sentences or instruction texts to coordinate multiple models; as a result, a generative AI model may produce verbose or irrelevant text that is not tightly coupled to the results of prior computational stages, which degrades the usefulness of the output and may cause additional manual work. Furthermore, typical server-side implementations do not provide a systematic way to combine a primary machine-generated anomaly indicator with a secondary generative explanation and to apply business rules on the combined information. Consequently, computing resources are inefficiently consumed, manual review is still frequently required, and overall system performance, including processing speed, accuracy, and scalability, remains suboptimal. There is therefore a need for an improved computer-implemented architecture in which a server coordinates multiple generative AI models and structured prompt sentences to perform staged judgments, generate consistent explanatory information, and algorithmically determine when manual review is required, thereby improving the operation of the computer system itself.

The specific processing by the specific processing unit 290 of the data processing device 12 in Example 2 is realized by the following means.

The present invention provides a server comprising a processor configured to receive, from a user device, information data and instruction information including a prompt sentence, convert the information data and the prompt sentence into a machine-processable format, execute a first generative AI model to generate a primary judgment result including an anomaly degree indicator and a coarse judgment category with respect to the information data, generate an instruction text including the primary judgment result, data type information, judgment condition information, and the prompt sentence, execute a second generative AI model using the instruction text and the information data to generate a final judgment result and explanatory information including at least presence or absence of an anomaly, a type of the anomaly, and a reason description, integrate the primary judgment result and the final judgment result by applying stored business rules based on the anomaly degree indicator and contents of the final judgment result, and generate and output review result data including information indicating necessity of manual review and recommended processing content to an external device. This enables staged, model-coordinated processing in which a computationally efficient primary model produces structured anomaly indicators that are programmatically fed into a secondary generative AI model via a controlled instruction text, thereby improving server-side decision accuracy, reducing processing latency, stabilizing explanatory outputs, and algorithmically reducing manual review operations while increasing the throughput and reliability of the computer-based review system.

The term “information data” refers to digital content provided by a user, including but not limited to image data, text data, numerical data, or any other electronically represented data that is to be analyzed by the system.

The term “instruction information” refers to digital control data associated with information data, including a prompt sentence and optional metadata, that specifies how a generative AI model is to process or evaluate the information data.

The term “prompt sentence” refers to a natural-language or structured-language text string that instructs a generative AI model regarding a task to be performed, an evaluation criterion, an output format, or a level of detail for generated results.

The term “machine-processable format” refers to a data representation that can be directly consumed by a computing device or machine learning model, including but not limited to token sequences, numerical tensors, normalized image arrays, encoded text, or serialized data structures.

The term “generative AI model” refers to a machine learning model configured to generate output data, such as text, images, or other signals, based on input data and learned parameters, including but not limited to neural network-based models such as sequence models, transformer models, or diffusion models.

The term “first generative AI model” refers to a generative AI model used in an initial processing stage to produce a primary judgment result, including at least an anomaly degree indicator and a coarse judgment category, based on information data and a prompt sentence.

The term “second generative AI model” refers to a generative AI model used in a subsequent processing stage to generate a final judgment result and explanatory information, based on an instruction text and information data that include outputs from the first generative AI model.

The term “primary judgment result” refers to an intermediate evaluation produced by the first generative AI model, including at least an anomaly degree indicator and a coarse judgment category for the information data.

The term “anomaly degree indicator” refers to a numerical or categorical value representing a degree or likelihood of abnormality, deviation, or inconsistency of the information data with respect to a learned normal pattern or expected behavior.

The term “coarse judgment category” refers to a simplified classification label that broadly categorizes the information data, such as normal, suspicious, abnormal, or another high-level status generated in a primary evaluation stage.

The term “instruction text” refers to a text string generated or assembled by the processor that includes at least the primary judgment result and the prompt sentence, and optionally includes data type information and judgment condition information, for use as input to the second generative AI model.

The term “data type information” refers to information indicating a category or format of the information data, such as image, text, transaction record, sensor log, or other data class used to guide processing by a generative AI model.

The term “judgment condition information” refers to information that specifies evaluation criteria, thresholds, constraints, or task definitions to be applied by a generative AI model when generating a judgment result.

The term “final judgment result” refers to a conclusive evaluation output generated by the second generative AI model, including at least a determination of presence or absence of an anomaly and, when applicable, a classification or description of the anomaly.

The term “explanatory information” refers to generated information that describes reasons or factors underlying a judgment result, including but not limited to natural-language explanations, categorized causes, or structured justification data.

The term “review result data” refers to output data generated by the processor that aggregates the primary judgment result, the final judgment result, and associated explanatory information, and that is intended for use by an external device or user interface.

The term “business rules” refers to configurable logic, conditions, or policies stored in a computing system and applied to the primary judgment result and the final judgment result in order to determine additional outcomes, including whether manual review is required or what follow-up actions are recommended.

The term “necessity of manual review” refers to an indicator or flag specifying whether human review or intervention is required for a particular case, based on combined judgment results and applied business rules.

The term “recommended processing content” refers to one or more suggested actions or procedures, such as approval, rejection, detailed inspection, escalation, or logging, to be performed in response to the review result data.

The term “external device” refers to any computing device, terminal, or system separate from the server that receives the review result data, including but not limited to a client terminal, user interface device, or another server.

In the following embodiments, a server cooperates with a terminal and a user to implement the claimed system. The server executes a stored program on one or more processors and uses a memory, a storage device, and a communication interface. The terminal includes, for example, a portable information device or a general-purpose computing device having a display unit, an input unit, and a communication unit. The user operates the terminal to supply information data and a prompt sentence.

The server includes a processor, a main memory, a non-volatile storage device, a network interface, and optionally a hardware accelerator such as a graphics processing unit. The server executes an operating system and an application framework that implements the functions described below. The server stores one or more generative AI models, parameters for such models, and business rules for integrating primary and final judgment results.

The terminal executes an operating system and application software that enables the user to capture or select information data, to input a prompt sentence, and to transmit these items to the server via a communication network. The terminal acquires, as information data, at least image data or text data. The terminal converts captured images to a general-purpose image format and converts input text to a standard character encoding. The terminal transmits the information data and the prompt sentence to the server via an encrypted communication protocol.

The user provides, as information data, for example, an image of a manufactured article, a document containing transaction records, or a screen capture including visual defects. The user also provides a prompt sentence indicating desired evaluation criteria or output form. The user may input, as the prompt sentence, for example:
“Please determine whether this product image contains any defects and describe the type and location of each defect.”
“Using this image, please determine whether there is any defect related to scratches, cracks, or contamination. Explain your judgment briefly.”
“Based on the following transaction description text, determine whether there is a risk of fraud and output a risk level (low, medium, or high) and an explanation.”

The server receives the information data and the prompt sentence from the terminal through the network interface. The server converts the information data and the prompt sentence into a machine-processable format. For image data, the server uses an image processing library (for example, a general-purpose image processing library) to decode the image into a numerical array, resize the array to a fixed resolution, and normalize pixel values into a predetermined numerical range. For text data, the server performs character normalization, encoding to a standard format, and segmentation into tokens using a tokenizer module.

The server stores the normalized information data in a memory structure suitable for input to a machine learning framework such as a tensor array. The server stores the prompt sentence, data type information, and judgment condition information as text fields in a structured data object. The server associates a unique identifier with each request and stores such identifier, the normalized information data, and the prompt sentence in a data store for traceability.

The server operates a first generative AI model to generate a primary judgment result including an anomaly degree indicator and a coarse judgment category. In one embodiment, the server implements the first generative AI model as a neural network trained using a supervised or self-supervised learning method. The server configures the first generative AI model as a relatively compact network to reduce computation time. For image data, the server may use a convolutional neural network or a vision transformer network that receives the normalized image tensor as input and outputs an embedding vector representing extracted visual features. For text data, the server may use a transformer-based sequence model that receives tokenized text as input and outputs an embedding representing semantic features.

The server uses the embedding vector to compute an anomaly degree indicator. In one embodiment, the server trains the first generative AI model as an autoencoder configured to reconstruct normal patterns of the information data. The server computes a reconstruction error between an input and a reconstruction. The server interprets a higher reconstruction error as a higher anomaly degree. The server uses a loss function, such as a mean squared error loss, during training to minimize reconstruction error on a training dataset representing normal data. The server updates the model weights using a gradient-based optimization algorithm. The server stores the trained parameters and uses them during inference. This architecture allows the server to compute anomaly indicators efficiently for unseen data without requiring explicit rule sets.

The server uses the anomaly degree indicator to assign a coarse judgment category. The server compares the anomaly degree indicator with one or more thresholds stored as configuration values. The server assigns a coarse judgment category such as “normal,” “suspicious,” or “abnormal” according to which range the anomaly degree indicator falls into.

The server stores the primary judgment result, including the anomaly degree indicator and the coarse judgment category, as part of a structured record.

The server constructs an instruction text to be input to a second generative AI model. The server generates the instruction text as natural language that includes the primary judgment result, data type information, judgment condition information, and the prompt sentence originally supplied by the user. The server may generate the instruction text according to a template such as:
“You are a technical inspection assistant. The input is of data type: image. A first-stage model has produced an anomaly score of 0.78 and categorized the data as ‘suspicious.’ Using the following user instruction: ‘Using this image, please determine whether there is any defect related to scratches, cracks, or contamination. Explain your judgment briefly.’ Analyze the input data and output a final judgment (normal or abnormal), the type of any defect, and a brief explanation.”

The server passes the instruction text and the information data to the second generative AI model. In one embodiment, the server implements the second generative AI model as a large-scale transformer-based generative model. The server encodes the instruction text into token sequences and, when image data is present, encodes the image into a visual feature representation using a vision encoder network. The server combines text tokens and visual features according to a multimodal architecture. The server configures the second generative AI model to output sequences of tokens representing descriptive text, structured labels, or both.

The server executes the second generative AI model using a machine learning framework that supports tensor operations and automatic differentiation. The server uses a hardware accelerator to improve throughput for matrix multiplication operations within the neural network layers. The server controls the decoding process in the generative model using parameters such as maximum sequence length, temperature, and sampling strategy. The server uses these parameters to promote stable and deterministic output when required by business rules.

The server receives, from the second generative AI model, a final judgment result and explanatory information. The server includes, in the final judgment result, at least presence or absence of an anomaly and, when an anomaly is detected, one or more anomaly types that may correspond to domain-specific defect categories. The server also obtains explanatory information that includes reasons why the anomaly was determined, such as a description of a scratch in a particular image region or a description of inconsistent numerical values in a transaction record.

The server integrates the primary judgment result and the final judgment result by applying business rules. The server stores business rules in a rule repository, for example, as a set of threshold-based conditions or weighted combinations of the anomaly degree indicator and specific tokens in the explanatory information. The server evaluates the business rules using a rule engine executed on the processor. The server determines, based on the evaluation, whether manual review is required and which processing action is recommended. The server generates review result data that includes the integrated decision, anomaly degree indicator, anomaly type information, explanatory information, a manual review necessity flag, and recommended processing content.

The server outputs the review result data to the terminal via the communication interface. The server formats the review result data in a structured format suitable for decoding by the terminal. The terminal receives the review result data, parses the structured format, and displays the final judgment and explanatory information on its display unit. The user views the displayed information and may use the recommendation to perform further actions in the physical environment, such as rejecting a defective product, flagging a transaction for further investigation, or confirming a normal status.

The server, by separating the processing into a primary generative AI model and a second generative AI model and by inserting a structured instruction text including machine-generated anomaly indicators, improves the internal operation of the computer system. The server reduces the computational load on the second generative AI model by using the primary generative AI model to filter out clearly normal cases or to compress information into anomaly indicators. The server improves accuracy and stability of the final decision by aligning the generative explanation with numerical indicators produced in the first stage. The server reduces network traffic and storage requirements by transmitting concise review result data instead of complete intermediate activations or full model states. The server decreases manual review workload by reliably flagging only those cases that exceed predetermined thresholds or are characterized as uncertain based on both numerical and textual indicators.

The server implements learning procedures for the generative AI models in a training phase that is separate from the inference phase. The server prepares training datasets consisting of labeled normal samples and, in some embodiments, labeled anomalous samples. The server applies data augmentation techniques such as random cropping, rotation, or noise injection for image data, and token masking or synonym replacement for text data, to increase robustness of the models. The server defines loss functions suited to each model's purpose. For the first generative AI model, the server may define reconstruction losses or distribution-matching losses. For the second generative AI model, the server may use supervised loss terms for classification outputs and language modeling loss terms for explanatory text. The server updates model weights by iterative optimization using stochastic gradient descent or similar algorithms. The server stores the trained model parameters in the storage device and loads them into memory during inference.

The server, by implementing these training and inference procedures, realizes a specific technical effect in computer operation. The server processes batches of information data more quickly than a single large generative model operating without staged filtering because the server allocates detailed generative processing only to cases that require it. The server reduces error rates in final decisions because the second generative AI model receives explicit anomaly degree indicators and data type information, which guide its generation process. The server improves fault diagnosis and monitoring because the server logs both numerical indicators and explanatory text, allowing operators to analyze errors at multiple levels of abstraction.

In one embodiment, the server applies the described architecture to quality inspection of manufactured articles. The user captures, using the terminal, an image of a product on a production line. The user inputs the prompt sentence:
“Please determine whether this product image contains any defects and describe the type and location of each defect.”

The terminal sends the image and prompt sentence to the server. The server normalizes the image and runs the first generative AI model to compute an anomaly degree indicator. The server classifies the image as “suspicious” and includes this classification and the anomaly degree indicator in the instruction text. The server runs the second generative AI model to generate a final judgment, for example, “abnormal,” and an explanation such as “a crack is visible along the left edge.” The server applies business rules to determine that manual review is required only for products with anomaly degree indicators greater than a specified threshold and with certain types of anomalies. As a result, the server allows the factory system to automatically pass normal products without human intervention while directing only high-risk products to human inspectors. This produces a direct improvement in throughput and reduces the number of images that must be visually examined by humans.

In another embodiment, the server applies the same architecture to text-based transaction monitoring. The user inputs a text description or a structured log of a financial transaction and inputs the prompt sentence:
“Based on the following transaction description text, determine whether there is a risk of fraud and output a risk level (low, medium, or high) and an explanation.”

The terminal transmits the data and the prompt sentence. The server tokenizes the text, runs the first generative AI model to compute an anomaly degree indicator related to statistical deviation from typical transaction patterns, and categorizes the transaction as “suspicious” when the anomaly degree exceeds a threshold. The server embeds this information into the instruction text for the second generative AI model. The second generative AI model outputs a final judgment, such as “high risk,” together with an explanation that highlights unusual amounts or destinations. The server applies business rules to prioritize or queue cases for further automated or manual processing. This arrangement improves the ability of the computer system to identify complex fraudulent patterns that cannot be effectively captured by static rule sets alone.

The server can implement variations of the described architecture. The server can use different neural network architectures for the first generative AI model, such as recurrent networks for sequential sensor data or graph neural networks for relational data, while maintaining the concept of generating anomaly degree indicators. The server can configure the second generative AI model as a model that outputs structured labels instead of or in addition to free-form text. The server can adjust thresholds and business rules dynamically based on monitored performance metrics. The server can deploy models across multiple hardware accelerators to allow parallel processing of requests.

The server, the terminal, and the user cooperate in these embodiments to realize a technical effect that extends beyond mere automation of human review. The server optimizes internal resource allocation by using staged analysis and structured prompt sentences, reduces computation and communication loads, and generates integrated numerical and textual outputs that support more accurate and efficient decision making by downstream systems.

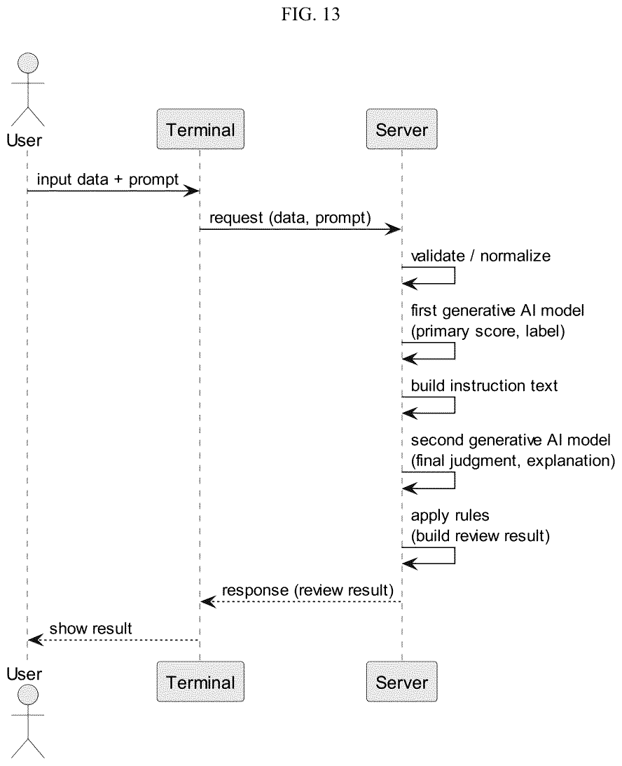

The following describes the processing flow using FIG. 13.

### Step 1:

The user prepares information data and a prompt sentence. The user operates the terminal to capture or select information data, such as an image of a product or a text document describing a transaction. The user inputs a prompt sentence that specifies how a generative AI model should analyze the information data, for example, “Please determine whether this product image contains any defects and describe the type and location of each defect.” The input of this step is raw information data and a human-readable prompt sentence. The output of this step is a set of user-specified inputs stored in the terminal's local memory, ready to be transmitted to the server.

### Step 2:

The terminal converts the user inputs into a transmission-ready format. The terminal receives the raw information data and the prompt sentence from the user interface. The terminal performs data preprocessing, such as converting an image to a standard format (for example, JPEG or PNG), resizing the image to a fixed resolution, and encoding the prompt sentence and any associated text in a standard character encoding such as UTF-8. The terminal then constructs a request object that includes the processed information data, the prompt sentence, and metadata such as data type and user identifier. The input of this step is the raw information data and prompt sentence from Step 1. The output of this step is a structured request payload that can be transmitted to the server over a network.

### Step 3:

The terminal transmits the request payload to the server. The terminal establishes a secure communication channel to the server using a network protocol and issues a request that includes the structured request payload. The terminal waits for a response and may display a progress indicator to the user. The input of this step is the structured request payload from Step 2. The output of this step is a network message sent to the server and an internal state in which the terminal is awaiting the server's review result.

### Step 4:

The server receives the request payload and performs initial validation. The server accepts the network message, extracts the information data, the prompt sentence, and associated metadata, and checks basic validity conditions such as file type, file size, and presence of required fields. The server rejects malformed inputs or unsupported formats and returns an error response if validation fails. The input of this step is the transmitted request payload from Step 3. The output of this step is either an error response (for invalid cases) or a validated and parsed representation of the information data and prompt sentence stored in server memory.

### Step 5:

The server normalizes the information data into model-ready representations. The server uses an image processing or text processing library to convert the validated information data into numerical arrays or token sequences. For image data, the server decodes the image file, resizes it, normalizes pixel values to a specified range, and stores the result as a tensor. For text data, the server performs tokenization and converts tokens into numerical identifiers. The server stores the normalized prompt sentence as a text string or as a token sequence, depending on the downstream model requirements. The input of this step is the validated information data and prompt sentence from Step 4. The output of this step is a set of normalized data structures, including at least a model-ready representation of the information data and a machine-processable representation of the prompt sentence.

### Step 6:

The server computes a primary judgment using a first generative AI model. The server feeds the normalized information data, and optionally the prompt sentence or derived features, into the first generative AI model. The server executes the model to obtain intermediate features and a reconstruction or prediction. The server computes an anomaly degree indicator, for example by calculating a difference between the input and a reconstruction or by evaluating a probability measure under the model's learned distribution. The server categorizes the information data into a coarse judgment category, such as “normal” or “suspicious,” based on thresholds applied to the anomaly degree indicator. The input of this step is the normalized information data and prompt representation from Step 5. The output of this step is a primary judgment result that includes at least the anomaly degree indicator and the coarse judgment category.

### Step 7:

The server generates an instruction text for a second generative AI model. The server combines the primary judgment result, data type information, judgment condition information, and the original prompt sentence into a structured natural-language instruction. The server may embed numeric values, such as the anomaly degree indicator, into the instruction text in a human-readable form. The server formats the instruction text so that it can guide the second generative AI model to produce a detailed final judgment and explanation. The input of this step is the primary judgment result and the original prompt sentence from Step 6, together with metadata from Step 5. The output of this step is a constructed instruction text that encodes, in natural language, both model-generated indicators and user-specified requirements.

### Step 8:

The server executes a second generative AI model to obtain a final judgment and explanatory information. The server encodes the instruction text into tokens and, when necessary, encodes the information data into corresponding feature vectors. The server inputs these representations into the second generative AI model and runs a generation process that outputs a text sequence or structured data. The server interprets this output to derive a final judgment result, such as presence or absence of an anomaly and one or more anomaly types, and to obtain explanatory information describing the reasons for the judgment. The input of this step is the instruction text from Step 7 and the normalized information data from Step 5. The output of this step is the final judgment result and the associated explanatory information.

### Step 9:

The server integrates the primary and final judgments and applies business rules. The server places the anomaly degree indicator, the coarse judgment category, the final judgment result, and the explanatory information into a unified data structure. The server retrieves configured business rules and applies them to these values, for example by comparing the anomaly degree indicator to thresholds or checking for specific anomaly types in the final judgment. The server determines whether manual review is required and which processing action is recommended. The input of this step is the primary judgment result from Step 6 and the final judgment and explanatory information from Step 8. The output of this step is integrated review result data that includes an overall status, a manual review necessity flag, and recommended processing content.

### Step 10:

The server generates and sends a response containing the review result data. The server formats the integrated review result data into a response message suitable for transmission to the terminal. The server includes fields such as overall decision, anomaly degree indicator, anomaly types, explanation text, manual review necessity, and recommended actions. The server transmits this response through the network interface to the terminal that issued the original request. The input of this step is the integrated review result data from Step 9. The output of this step is a network response message carrying the review result data.

### Step 11:

The terminal receives and presents the review result to the user. The terminal accepts the network response from the server and parses the contained review result data. The terminal updates its user interface to display the overall decision (for example, “normal” or “abnormal”), the explanation text, and any recommended actions. The terminal may highlight critical findings or provide buttons for the user to confirm, escalate, or reject within the application. The input of this step is the response message from Step 10. The output of this step is a visual or interactive presentation of the review result on the terminal's display.

### Step 12:

The user reviews the presented result and takes further action. The user inspects the displayed decision, explanation, and recommendations. The user may, for example, decide to discard a defective product, approve a normal case, or trigger a separate manual review workflow. The input of this step is the information shown on the terminal's display from Step 11. The output of this step is a user decision or action that uses the system's computed review result as a basis.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional electronic communication systems between guardians and educators generally treat messages as unstructured text and rely on human operators to read, interpret, and draft appropriate responses. As a result, several technical problems arise in computing environments that manage such communication at scale.

First, existing systems typically perform only simple keyword search and template matching on stored messages, without executing deeper semantic analysis or emotion analysis. Because the server does not structurally model intent, sentiment, or emotional state, the server is unable to adapt its response generation behavior to different guardians or changing contexts. This leads to inefficient use of computing resources, since the system cannot prioritize or filter candidate responses based on quantitative indicators such as a reliability index or an emotion state index, and therefore often presents generic, low-value suggestions that require extensive manual rewriting.

Second, generative AI models are often invoked in a stateless manner, where each call receives only the current message content as input. The server does not maintain or exploit a structured history of past interactions, such as prior prompts, generated replies, teacher edits, and guardian reactions. Because the server fails to use such history information to dynamically generate optimized prompt sentences and to control the output of the generative AI model, the same or similar errors and inappropriate tones are repeated. This results in unnecessary processor cycles, repeated network calls to external AI services, and redundant editing work on terminals, thereby reducing overall system throughput and scalability.

Third, known systems do not integrate a feedback loop in which client-side editing operations and guardian responses are fed back into a server-side control mechanism. In the absence of a feedback loop, the server cannot automatically learn which reply patterns increase a guardian's sense of reassurance and trust, and which patterns lead to complaints or follow-up questions. Consequently, the server cannot re-rank or filter multiple AI-generated reply candidates based on model-specific reliability indices combined with guardian-specific emotion state indices. This results in suboptimal selection of candidate responses, increased data traffic due to repeated exchanges, and wasted computational resources.

Accordingly, there is a need for an improved computer-implemented communication system in which a server performs structured semantic and emotion analysis, maintains and updates interaction history, dynamically generates and optimizes prompt sentences for a generative AI model, and controls selection and presentation of reply candidate information. Such a system should reduce processing load on educators' terminals, improve utilization of server-side processing and AI inference resources, and enhance the effectiveness and stability of communication by automatically favoring reply content that quantitatively increases guardians' reassurance and trust, thereby improving the functioning of the underlying computer system itself.

The specific processing by the specific processing unit 290 of the data processing device 12 in Application Example 2 is realized by the following means.

The present invention provides a server comprising a processor configured to receive guardian communication information and perform semantic analysis and emotion analysis on the guardian communication information, to generate, on the basis of an analysis result and past response history with the guardian, a prompt sentence to be input to a generative AI model, to input the prompt sentence to the generative AI model and thereby generate a plurality of pieces of reply candidate information, to select, on the basis of a reliability index output together with the reply candidate information and an emotion state index of the guardian, reply candidate information expected to increase a sense of reassurance and a sense of trust of the guardian, to present the selected reply candidate information to a teacher terminal and accept an editing operation by a teacher to acquire corrected reply information, and to transmit the corrected reply information to a guardian terminal while storing, as history information, editing content by the teacher and a response result from the guardian and reflecting the history information in subsequent generation of the prompt sentence and in output control of the generative AI model. This enables the server to structurally model user intent and emotion, to dynamically optimize prompt sentences and response selection based on quantitative feedback, and to reduce overall computational load and latency in generating effective replies, thereby improving the technical performance and adaptability of the computer-implemented communication system.

The term “guardian communication information” refers to message content and related metadata transmitted from a guardian to an educator through an electronic communication medium, including at least text data and optionally additional contextual information such as timestamps, sender identifiers, and communication channels.

The term “semantic analysis” refers to a computational process in which a processor interprets natural language text to extract structured information such as intent, topics, key phrases, and relationships between entities, using language processing algorithms.

The term “emotion analysis” refers to a computational process in which a processor evaluates input data, including at least natural language text and optionally other signals, to estimate an emotional state of a user, such as concern, reassurance, trust, anger, or anxiety, and to represent the estimated emotional state as one or more emotion labels and associated scores.

The term “analysis result” refers to structured data produced by semantic analysis and emotion analysis, including at least identified intents, topics, sentiment or emotion labels, and associated indicators that characterize the content and emotional tone of a received message.

The term “past response history” refers to stored interaction records between a guardian and an educator, including at least past messages, previously generated replies, teacher edits, guardian reactions, and any associated evaluation or outcome information.

The term “prompt sentence” refers to a machine-interpretable natural language instruction or query generated by a processor and provided as input to a generative AI model, the instruction or query specifying a desired content, style, or purpose of output to be produced by the generative AI model.

The term “generative AI model” refers to an information processing model implemented in software and/or hardware that, in response to an input such as a prompt sentence, generates new data including at least natural language text, by applying learned statistical or neural computations.

The term “reply candidate information” refers to one or more pieces of machine-generated response content, including at least natural language text proposed as a potential reply to a guardian, and optionally associated metadata such as scores, tags, or categories.

The term “teacher terminal” refers to an electronic device operated by an educator and configured to communicate with a server, to display reply candidate information, and to accept editing input from the educator, the device including at least a display and an input interface.

The term “editing operation” refers to one or more user actions performed via a teacher terminal to modify reply candidate information, including at least insertion, deletion, or replacement of text, and optionally reordering, approval, or rejection of candidate responses.

The term “corrected reply information” refers to reply content obtained after a teacher has performed an editing operation on reply candidate information, the reply content being intended as a final or semi-final message to be transmitted to a guardian.

The term “guardian terminal” refers to an electronic device operated by a guardian and configured to receive and display reply information from a server, the device including at least a communication interface, a display, and an input mechanism for further responses.

The term “history information” refers to data stored by a server that records past interactions and processing events, including at least teacher editing content, guardian responses, associated timings, and any derived evaluation indicators.

The term “output control of the generative AI model” refers to adjustment operations performed by a processor on parameters, inputs, or selection logic associated with a generative AI model, in order to influence characteristics of the model's output, such as tone, length, style, or content focus.

The term “reliability index” refers to a quantitative indicator associated with reply candidate information, computed by a model or by post-processing logic, that represents an estimated quality, appropriateness, or confidence level of a given candidate reply.

The term “emotion state index” refers to a numerical or categorical representation of a guardian's emotional state, derived from emotion analysis of communication data, and used as a parameter for selecting or ranking reply candidate information.

The term “sense of reassurance” refers to a subjective state of reduced anxiety or concern of a guardian, which is targeted to be increased by selecting or generating reply content that is judged, based on analysis and history, to alleviate worry.

The term “sense of trust” refers to a subjective state in which a guardian has confidence in an educator or an institution, which is targeted to be increased by selecting or generating reply content that is judged, based on analysis and history, to reinforce credibility and reliability.

The term “communication effectiveness” refers to a degree to which exchanges between a guardian and an educator achieve intended communication goals, including resolution of concerns, reduction of misunderstandings, and reduction of repeated follow-up messages, as evaluated on the basis of stored history information and system metrics.

In one embodiment, the invention is implemented in a client-server communication system in which a server, one or more teacher terminals, and one or more guardian terminals are interconnected through a communication network. The server includes at least one processor, a main memory, a non-transitory storage device, and a network interface. The server executes software modules for natural language processing, emotion analysis, prompt sentence generation, interaction history management, and inference control for a generative AI model. The teacher terminal and the guardian terminal each include a processor, a memory, a display device, and an input device, and execute an application that exchanges data with the server over a network using a defined protocol such as HTTPS.

The server generates program components that implement a pipeline for receiving guardian communication information, transforming the communication information into structured internal representations, generating and controlling prompt sentences for a generative AI model, selecting reply candidate information based on quantitative indices, and feeding back teacher edits and guardian responses into subsequent processing. The server stores these program components on a non-transitory storage medium and loads them into memory for execution by the processor.

The server uses a natural language processing library, such as a general-purpose text analysis library, to perform tokenization, part-of-speech tagging, dependency parsing, and named entity recognition on the guardian communication information. The server represents each incoming message as a data structure including, for example, an array of token identifiers, a parse tree, a list of recognized entities, and associated feature vectors. The server additionally applies an emotion analysis model, which may be implemented as a neural network classifier, to compute an emotion state index for the guardian message. The emotion analysis model can be, for example, a bidirectional recurrent neural network or a transformer-based classifier trained on labeled emotional text data, and outputs probabilities for emotion labels such as “concerned”, “angry”, “reassured”, or “neutral”.

The server stores an analysis result that includes at least an intent label, key phrases, and the emotion state index in a structured message record in a database. The server also maintains past response history for each guardian, where each history record includes the original guardian communication information, one or more prompt sentences previously generated, one or more pieces of reply candidate information generated by the generative AI model, editing operations performed by a teacher, corrected reply information actually transmitted, and reaction indicators for the guardian, such as whether a follow-up question was sent or whether an explicit appreciation message was returned.

The server uses the analysis result and the past response history to generate a prompt sentence for the generative AI model. The server executes a prompt generation module that applies a rule-based template selection algorithm and a learned ranking model. The server first selects a base template according to the detected intent, for example a “concern about behavior” template, a “schedule clarification” template, or a “health report” template. The server then adjusts the template based on the emotion state index and guardian-specific history, for example by including phrases that have historically resulted in fewer follow-up questions for that guardian profile.

The server generates a prompt sentence in natural language that explicitly instructs the generative AI model about desired tone, length, and content constraints. For example, the server generates a prompt sentence such as:
“Generate a concise, polite, and reassuring reply to a guardian who wrote: ‘I am worried about my child's attitude in class.’ Include at least one positive observation about the child and one suggestion for how school and home can work together.”

In another example, when the server has access to additional context, the server generates a prompt sentence such as:
“A guardian is worried about their child's classroom attitude and is seeking reassurance. Based on the following teacher notes (the child often participates actively but sometimes loses focus), please generate a polite, reassuring reply that includes positive feedback and a concrete plan for cooperation with the guardian.”

The server inputs the prompt sentence and, optionally, additional context text into a generative AI model as a text sequence. The generative AI model is implemented as a neural language model that can be, for example, a transformer-based architecture trained on large text corpora. The generative AI model internally converts the prompt sentence into embeddings, processes the embeddings through multiple self-attention layers, and produces output token probabilities, which are sampled or decoded (for example, using beam search or top-k sampling) to generate one or more pieces of reply candidate information. The server can run the generative AI model on a dedicated inference engine, which may be located on the same server hardware or on a remote computing resource accessible via an application programming interface.

The server, in one implementation, configures the generative AI model with specific hyperparameters, such as a fixed number of transformer layers, a defined hidden dimension size, and specific attention head counts. The server additionally sets decoding parameters such as maximum output length, temperature, and sampling strategy to control the style and determinism of generated replies. The server may generate multiple candidate replies by varying decoding parameters or by issuing multiple slightly varied prompt sentences.

The server obtains, for each piece of reply candidate information, a reliability index. In one embodiment, the reliability index is generated by a separate evaluation model that measures consistency of the candidate with the prompt constraints and with policy rules, such as avoidance of prohibited expressions and alignment with predetermined tone guidelines. The evaluation model may be a classifier that takes as input the prompt sentence and the candidate reply and outputs a score between 0 and 1. In another embodiment, the server derives the reliability index from internal likelihood scores of the generative AI model, such as average log-probability per token.

The server uses both the reliability index and the emotion state index of the guardian to select which reply candidate information to present to the teacher terminal. For example, when the emotion state index indicates a highly concerned guardian, the server prioritizes replies that contain more reassurance phrases and fewer technical details, as determined by pattern analysis of the candidate content and by similarity to previously successful replies in the history. The server applies a ranking algorithm that combines the reliability index with a guardian-specific weight vector derived from the past response history. This ranking algorithm enables the server to select a subset of candidate replies that is more likely to reduce concern and increase trust, while discarding lower-quality or mismatched responses before they are transmitted to the terminal.

The server transmits the selected reply candidate information to the teacher terminal in a structured format. The teacher terminal receives the candidate reply through the network interface and renders it on a display in an editable area. The teacher views the reply candidate information and may perform editing operations such as modifying phrases, adding specific details, or adjusting formality. The teacher terminal captures these editing operations as structured edit logs, for example as a sequence of insertion, deletion, and replacement operations at specific positions.

The terminal sends the corrected reply information and the edit logs back to the server. The server stores the corrected reply information as part of the history information and associates the edit logs with the original candidate reply and the prompt sentence. The server uses this stored edit log to adjust future prompt generation and to update parameters of the evaluation or ranking components. For example, the server may compute statistics on which parts of generated replies consistently require editing for a particular guardian, and adapt future prompt sentences to pre-bias the generative AI model toward more appropriate patterns.

The server then transmits the corrected reply information to the guardian terminal. The guardian terminal receives the message and displays it in a communication interface. The guardian may optionally respond with a new message, which the server again processes through semantic analysis and emotion analysis. The server records whether the corrected reply information resulted in additional questions, explicit satisfaction messages, or no further responses. The server encodes this reaction as part of the response result of the guardian and incorporates it into the history information.

The server, by iteratively updating prompt sentence generation and selection logic using the history information, improves the quality of initial candidate replies and reduces the average number of edits required on the teacher terminal. As a result, the server reduces the volume of data transmitted back and forth for multiple correction cycles, thereby lowering communication load. The server also reduces processing time by reducing the need to re-invoke the generative AI model for additional candidate replies, which in turn lowers computational cost and latency.

The system provides technical improvements over conventional messaging systems in several ways. The server transforms unstructured text messages into structured internal representations that are optimized for machine processing, including intent labels, emotion state indices, and history-based behavioral profiles. The server then uses these structured representations to generate prompt sentences that more precisely condition the generative AI model, enabling the model to produce replies that are better aligned with the desired tone and content constraints. This reduces the amount of post-editing work and thereby reduces resource consumption on both the server and the terminals.

In contrast to merely automating human drafting, the server applies non-conventional processing flows that explicitly integrate quantitative reliability indices and emotion state indices into the selection of reply candidate information. The server does not simply present all generated content to the teacher, but instead executes ranking and filtering algorithms that operate on machine-interpretable indices and structural features. This leads to a measurable improvement in communication accuracy and consistency and improves the throughput of the communication system in a way that could not be achieved by manual triage alone.

The generative AI model, in one exemplary implementation, is trained using supervised learning on a dataset of message-reply pairs. The server uses a loss function such as cross-entropy over target tokens, and updates model parameters using a gradient-based optimizer such as stochastic gradient descent or adaptive moment estimation. The server may apply data augmentation techniques such as paraphrasing or synonym replacement to improve robustness. The emotion analysis model can be trained separately with an objective that minimizes classification error on labeled emotional text data. The evaluation model for reliability index can be trained to distinguish high-quality and low-quality replies based on human ratings, using a margin-based ranking loss.

The server coordinates these models within a modular architecture in which each module consumes and produces well-defined data structures. This modular architecture allows the server to parallelize and cache intermediate results, such as semantic analysis outputs and emotion estimates, to avoid repeated computation. The server can also batch multiple prompt sentences for inference on the generative AI model, increasing hardware utilization efficiency and reducing overall latency per message.

In another embodiment, the server may employ a different neural architecture for the generative AI model, such as a recurrent neural network with attention mechanisms or a convolutional sequence model, depending on deployment constraints. The core mechanism of generating prompt sentences based on analysis results and history information, and controlling selection of reply candidate information based on reliability index and emotion state index, remains the same. In a further variant, the server can run a locally deployed generative AI model on dedicated accelerators, rather than relying on a remote inference service, to reduce network dependency and to provide lower latency.

The terminal implementations can also vary. In one embodiment, the teacher terminal is a desktop computer executing a browser application, and the guardian terminal is a smartphone executing a native application. In another embodiment, both the teacher terminal and the guardian terminal are tablets running a cross-platform application framework. In all cases, the terminal acts as an interface for displaying server-generated candidate replies and for capturing user edits or responses, while the main processing of semantic analysis, emotion analysis, prompt sentence generation, and candidate selection executes on the server.

By structuring the internal data, controlling prompt generation and model behavior with quantitative indices, and creating a closed feedback loop that updates processing based on teacher and guardian behavior, the server improves technical aspects such as processing speed, accuracy of reply selection, resource utilization, and network traffic efficiency. These improvements are tied to specific algorithms and data structures executed within the computer system and therefore constitute more than an abstract automation of human communication tasks.

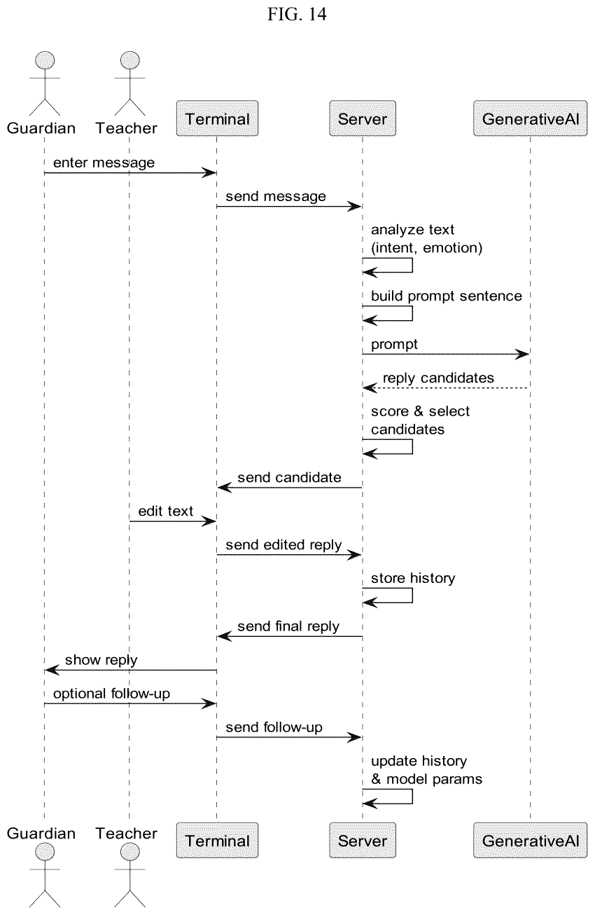

The following describes the processing flow using FIG. 14.

### Step 1:

The terminal transmits guardian communication information to the server.

The terminal uses a communication application to accept text input from the user (guardian), attaches metadata such as a guardian identifier, a child identifier, and a timestamp as an input, and sends these data to the server via a secure protocol.

The output of the terminal in this step is a formatted message object that includes the raw text and associated identifiers.

### Step 2:

The server receives the guardian communication information and stores it in a database.

The server takes the formatted message object as input, verifies authentication tokens, and writes the message text and metadata into a message table as a new record, assigning an internal message ID.

The output of the server in this step is a stored message record with a unique message identifier.

### Step 3:

The server performs semantic analysis on the stored message.

The server uses the message text as input and applies a natural language processing library to perform tokenization, part-of-speech tagging, dependency parsing, and key phrase extraction.

The server converts the parsed result into a structured data object that contains an intent label, a list of key phrases, and syntactic features as an output.

### Step 4:

The server performs emotion analysis on the stored message.

The server uses the same message text, optionally combined with the syntactic features, as an input to an emotion classification model implemented as a neural network.

The server calculates emotion probabilities for multiple labels, computes an emotion state index vector, and outputs the emotion state index associated with the message.

### Step 5:

The server combines the semantic analysis result and the emotion analysis result into an analysis result record.

The server uses the intent label, key phrases, and emotion state index as inputs, and constructs a unified data structure that associates these fields with the message ID.

The server outputs an analysis result record and stores it in an analysis table linked to the message record.

### Step 6:

The server retrieves past response history for the corresponding guardian.

The server uses the guardian identifier as input to query a history table that contains records of previous messages, prompt sentences, generated reply candidates, teacher edits, and guardian reactions.

The server outputs a history data object that aggregates relevant past interaction features for that guardian.

### Step 7:

The server generates a prompt sentence for a generative AI model based on the analysis result and the past response history.

The server uses the analysis result record and the history data object as inputs to a prompt generation module that selects a template, fills variable parts with current intent and emotion summaries, and optionally inserts condensed teacher notes.

The server outputs a concrete prompt sentence in natural language, for example: “Generate a concise, polite, and reassuring reply to a guardian who wrote: ‘I am worried about my child's attitude in class.’ Include at least one positive observation about the child and one suggestion for how school and home can work together.”

### Step 8:

The server sends the prompt sentence and context text to the generative AI model and generates multiple reply candidate information pieces.

The server uses the prompt sentence and optional context (such as short teacher notes) as input to a generative AI model through an inference interface, and configures decoding parameters such as maximum length and sampling strategy.

The server receives multiple generated texts as output and stores each as reply candidate information associated with the message ID and the prompt sentence.

### Step 9:

The server computes a reliability index for each piece of reply candidate information.

The server uses each candidate reply and the corresponding prompt sentence as inputs to an evaluation model or scoring algorithm that measures conformity to content constraints, tone guidelines, and safety rules.

The server outputs a numerical reliability index for each candidate reply and attaches these indices to the candidate records.

### Step 10:

The server selects reply candidate information based on the reliability indices and the emotion state index.

The server uses the set of reliability indices and the emotion state index from the analysis result as inputs to a ranking algorithm that calculates a composite score for each candidate, for example by weighted combination of the indices.

The server outputs an ordered list of candidate replies and selects at least one top-ranked candidate to be presented to the teacher terminal.

### Step 11:

The server transmits the selected reply candidate information to the teacher terminal.

The server uses the selected candidate text, its reliability index, and brief contextual metadata as inputs to a message packaging module that formats a response payload for the teacher terminal.

The server outputs the packaged payload via the network interface, addressed to the teacher terminal associated with the relevant class or student.

### Step 12:

The terminal displays the reply candidate information and records editing operations by the user (teacher).

The terminal receives the payload as input, renders the candidate reply text in an editable text area on the display, and provides UI controls for approval, modification, or rejection.

The user reviews the candidate reply, performs editing operations such as inserting, deleting, or replacing text, and the terminal records these operations as edit logs.

The output of the terminal in this step is corrected reply information and a structured record of editing operations.

### Step 13:

The terminal sends the corrected reply information and editing operations back to the server.

The terminal uses the corrected text and the edit logs as input, encapsulates them with the original message identifier and candidate identifier, and transmits them to the server over the network.

The output of the terminal in this step is an update payload containing the final reply text and operation history.

### Step 14:

The server stores the corrected reply information and updates history information.

The server uses the corrected reply text and edit logs as inputs, writes the corrected reply into a reply table linked to the message and guardian, and stores the edit logs in an edit history table.

The server outputs updated history information for that guardian, including references to the original candidate, the prompt sentence, and the final corrected reply.

### Step 15:

The server transmits the corrected reply information to the guardian terminal.

The server uses the corrected reply text and guardian identifier as inputs to a messaging module that formats a notification or message object for the guardian terminal.

The server outputs the message object through the network, addressed to the guardian terminal associated with the guardian identifier.

### Step 16:

The terminal displays the corrected reply information to the user (guardian) and optionally accepts a response.

The guardian terminal uses the incoming message object as input, renders the corrected reply text in the communication interface, and provides controls for the user to acknowledge or send a follow-up message.

The user reads the reply and may choose to send an additional message; the terminal then outputs new guardian communication information, which reenters the processing pipeline at Step 1.

### Step 17:

The server analyzes guardian reaction and updates response result indicators in the history information.

The server uses subsequent guardian behavior, such as absence of follow-up messages within a defined period, explicit thank-you messages, or additional complaints, as input to a reaction analysis module that interprets these patterns as response results.

The server outputs updated response result indicators, such as “resolved”, “requires further clarification”, or “escalated concern”, and stores these indicators in association with the corrected reply information.

### Step 18:

The server adjusts future prompt sentence generation and candidate selection parameters using the updated history information.

The server uses accumulated edit histories, reliability indices, emotion state indices, and response result indicators as inputs to a learning component that updates weights or parameters governing template selection, wording preferences, and ranking formula coefficients.

The server outputs revised configuration data for the prompt generation module and ranking module, which influence subsequent executions of Steps 7 through 10, thereby improving selection accuracy and reducing required editing in future interactions.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

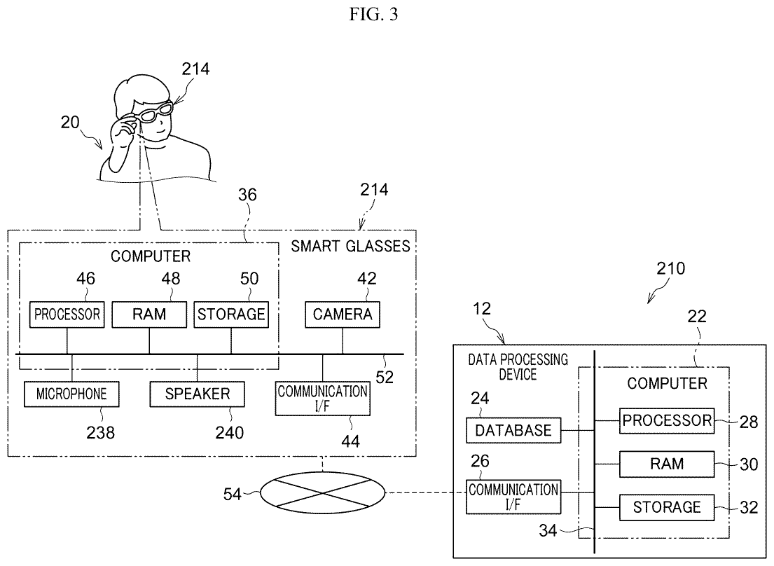

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

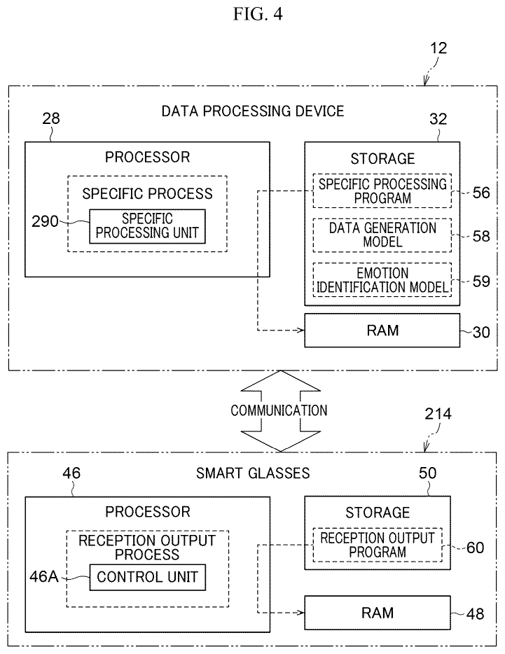

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

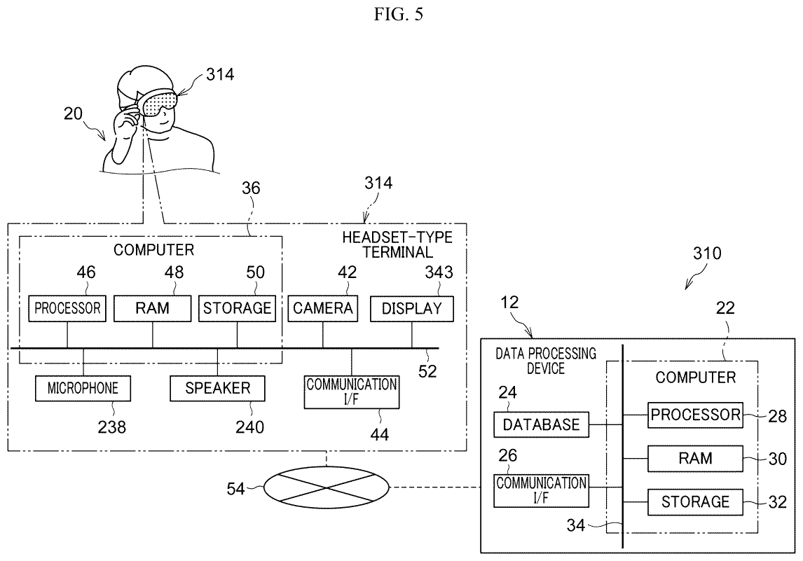

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

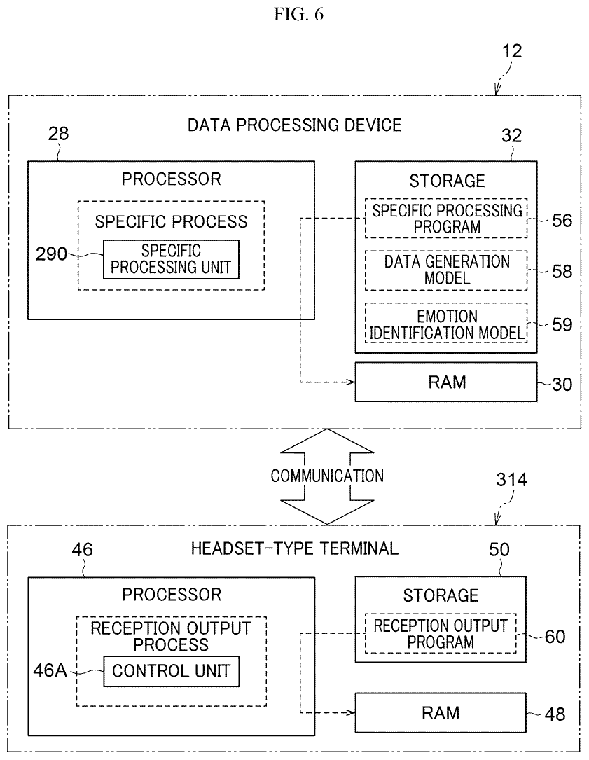

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

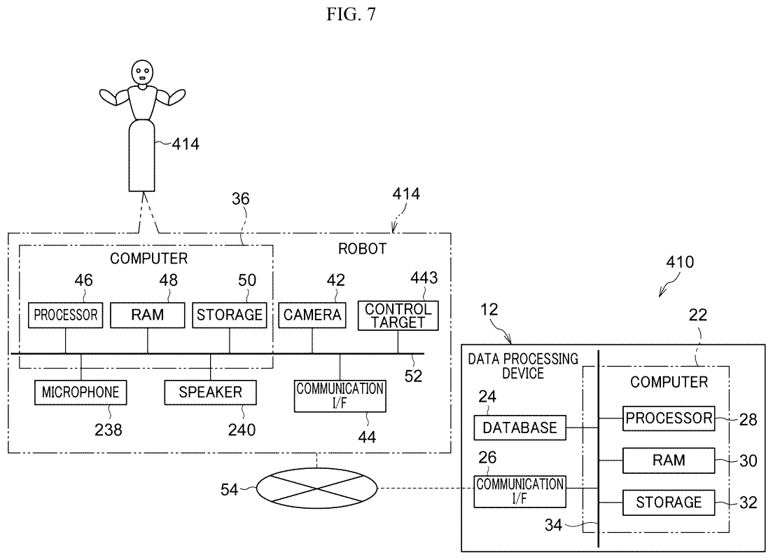

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

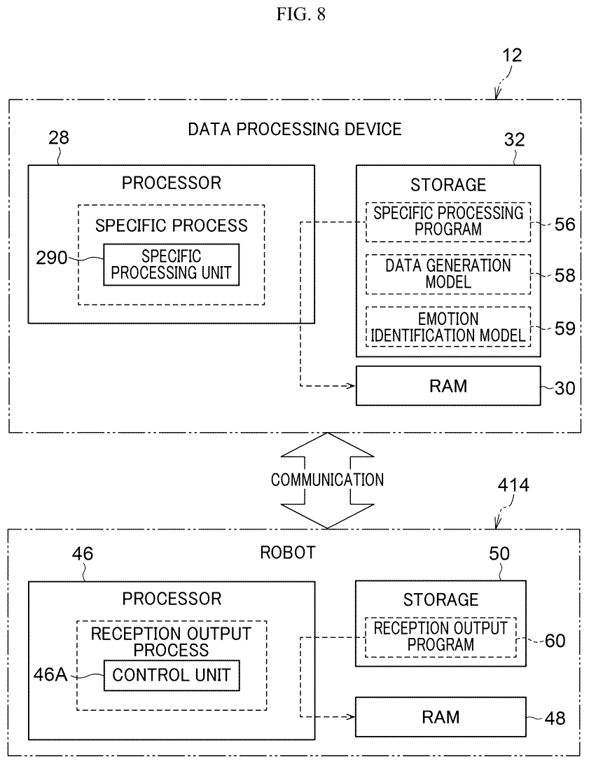

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

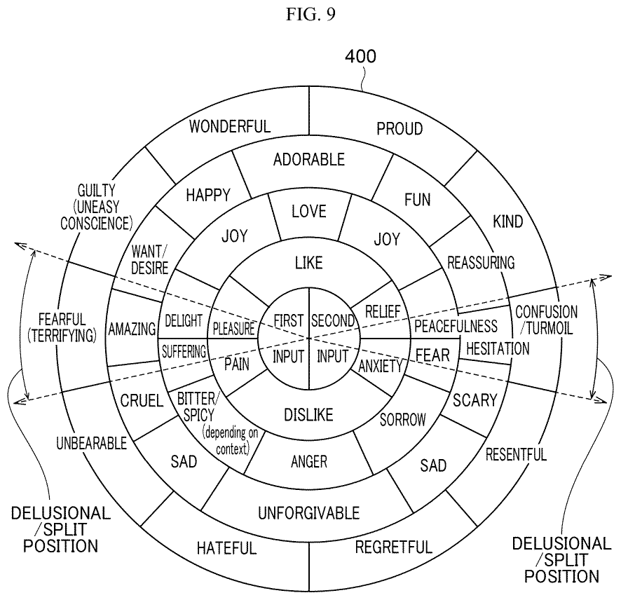

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

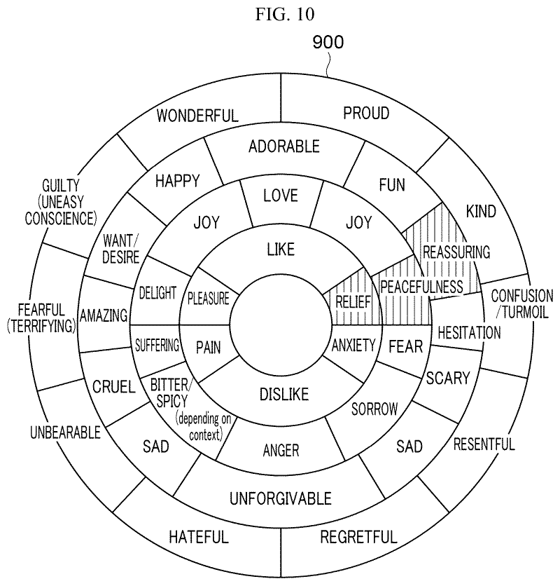

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from an information processing apparatus, input information including character information representing message content and transaction information including payment information, and to analyze the input information to generate analysis result information, generate, on the basis of the analysis result information and the input information, a first prompt sentence for generation of a reply-content candidate related to the message content, and input the first prompt sentence and the analysis result information into a generative AI model so as to cause the generative AI model to generate response information representing the reply-content candidate,
associate the response information with the transaction information as screening input information, generate a primary-judgment prompt sentence including at least a part of the transaction information, and input the primary-judgment prompt sentence into the generative AI model so as to obtain a primary-judgment result regarding a possibility of fraud in the transaction information,
generate, on the basis of the primary-judgment result and the transaction information, feature information representing characteristics of the transaction information, generate a final-judgment prompt sentence including the feature information and the primary-judgment result, and input the final-judgment prompt sentence into the generative AI model so as to obtain a final-judgment result regarding the possibility of fraud in the transaction information, generate examination-result information on the basis of the final-judgment result, output the examination-result information to a terminal apparatus, and cause a display apparatus to present the reply-content candidate and accept a correction operation by a user for the reply-content candidate.

### (Supplementary 2)

The system according to supplementary 1,
wherein the processor is configured to
control the first prompt sentence, the primary-judgment prompt sentence, and the final-judgment prompt sentence such that the reply-content candidate generated by the generative AI model includes content that increases a sense of reassurance and a degree of trust of a recipient of the message content, and such that the final-judgment result is output, as part of the examination-result information, in a form classified into at least one of “safe”, “possible fraud”, and “verification required” to the terminal apparatus.

### (Supplementary 3)

The system according to supplementary 1,
wherein the processor is configured to
use the reply-content candidate generated by the generative AI model to reduce working time required for creation of a reply to the message content by a user, and use the primary-judgment result and the final-judgment result for the transaction information to reduce processing time and cost related to fraud-countermeasure examination, thereby simultaneously maximizing communication effectiveness in message exchange and fraud-detection efficiency in payment transactions.

### Application Example 1

### (Supplementary 1)

A system comprising a processor,
wherein the processor is configured to
receive transaction information including payment information from a user terminal through a communication network, normalize the transaction information, store the normalized transaction information in a storage device together with a transaction identifier, extract past transaction history associated with a user identifier included in the transaction information from the storage device, and calculate statistical feature information representing behavioral characteristics of the user,
generate a prompt sentence for input to a generative AI model based on the statistical feature information and the transaction information, transmit inquiry data including the prompt sentence to the generative AI model, and acquire numerical information or classification information indicating a probability of fraud from the generative AI model,
compare the numerical information or the classification information acquired from the generative AI model with a predetermined reference value or determination condition, determine whether the transaction is a transaction having a possibility of fraud, and record, in the storage device, transaction management information including a fraud-suspected flag and examination result information,
generate notification data to be transmitted to the user terminal based on at least one of the fraud-suspected flag and the examination result information, the notification data including transaction content and an option for confirming validity of the transaction, and transmit the notification data to the user terminal,
receive response information from the user terminal indicating a user selection with respect to the option, update a settlement state of the transaction based on the response information, and accumulate the settlement state of the transaction as teacher data for machine learning, and update at least one of a structure of the prompt sentence and an output request condition for the generative AI model based on the accumulated teacher data, and dynamically adjust fraud determination processing to improve fraud detection accuracy.

### (Supplementary 2)

The system according to supplementary 1,
wherein the processor is configured to acquire first-stage fraud risk information by inputting a first prompt sentence to the generative AI model, and, when the first-stage fraud risk information satisfies a predetermined condition, generate a second prompt sentence including a determination result based on the first prompt sentence and external risk information, input the second prompt sentence to at least one of the generative AI model and another generative AI model, acquire a final fraud determination result, and hierarchically determine the fraud-suspected flag and the examination result information based on the first-stage fraud risk information and the final fraud determination result.

### (Supplementary 3)

The system according to supplementary 1,
wherein the processor is configured to coordinate generation of the prompt sentence for the generative AI model with reception of the transaction information in real time so as to perform fraud risk evaluation and notification to the user terminal at a time of occurrence of the transaction or at a time proximate thereto, and to control execution permission of the transaction based on the response information received from the user terminal.

### Example 2

### (Supplementary 1)

A system comprising a processor,
wherein the processor is configured to
receive, from a user, information data and instruction information including a prompt
sentence, and convert the information data and the prompt sentence into a machine-processable format,
operate a first generative AI model based on the converted information data and the prompt sentence to generate a primary judgment result including an anomaly degree indicator and a coarse judgment category with respect to the information data,
generate an instruction text including the primary judgment result and the prompt sentence, and input the instruction text and the information data into a second generative AI model to generate a final judgment result and explanatory information, and integrate the primary judgment result and the final judgment result to generate review result data and output the review result data to an external device.

### (Supplementary 2)

The system according to supplementary 1,
wherein the processor is configured to
configure the instruction text input to the second generative AI model to include data type information and judgment condition information based on the primary judgment result, thereby causing the second generative AI model to generate, as the final judgment result and the explanatory information, information including presence or absence of an anomaly, a type of the anomaly, and a reason description regarding the anomaly.

### (Supplementary 3)

The system according to supplementary 1,
wherein the processor is configured to
apply business rules based on the anomaly degree indicator of the primary judgment result and contents of the final judgment result, and output, in the review result data, information indicating necessity of manual review and recommended processing content, thereby reducing a manual workload of review processing while improving review accuracy and number of processed cases.

### Application Example 2

### (Supplementary 1)

A system comprising a processor,
wherein the processor is configured to
receive guardian communication information and perform semantic analysis and emotion analysis on the guardian communication information,
generate, on the basis of an analysis result and past response history with the guardian, a prompt sentence to be input to a generative AI model, input the prompt sentence to the generative AI model, and thereby generate reply candidate information,
present the reply candidate information to a teacher terminal, accept an editing operation by a teacher via the teacher terminal, and acquire corrected reply information, and
transmit the corrected reply information to a guardian terminal, store, as history information, editing content by the teacher and a response result from the guardian, and reflect the history information in subsequent generation of the prompt sentence and in output control of the generative AI model.

### (Supplementary 2)

The system according to supplementary 1,
wherein the processor is configured to select, in generation of the reply candidate information, reply candidate information to be presented on the basis of a reliability index of a plurality of pieces of reply candidate information output by the generative AI model and an emotion state index of the guardian, and to preferentially present, to the teacher terminal, reply candidate information that is expected to increase a sense of reassurance and a sense of trust of the guardian.

### (Supplementary 3)

The system according to supplementary 1,
wherein the processor is configured to reduce working time of the teacher by automatic generation of the reply candidate information and optimization processing of the prompt sentence based on an editing history of the teacher, and to automatically present reply information that enhances communication effectiveness by taking into account the emotion state index of the guardian and past communication history.

What is claimed is:

1. A system comprising:
circuitry configured to:
receive, via a communication interface coupled to a packet-switched network, input data comprising character-string data from a terminal device operated by a first user;
perform an analysis operation on the character-string data to generate analysis result data;
construct, based on the analysis result data, a token sequence for input to a trained neural network model, and cause the trained neural network model to execute an inference operation on the token sequence to generate response candidate data;
transmit the response candidate data to a second terminal device via the communication interface; and
receive, from the second terminal device, correction data representing a modification to the response candidate data by a second user.

2. The system according to claim 1,
wherein the circuitry is further configured to:
select, from a template repository stored in a storage device, template data corresponding to an intent category derived from the analysis result data; and
construct the token sequence by combining the character-string data with the template data and context data.

3. The system according to claim 2,
wherein the context data comprises at least one of past interaction history data associated with the first user and attribute data associated with the second user.

4. The system according to claim 3,
wherein the circuitry is further configured to:
generate a plurality of pieces of response candidate data by varying at least one of decoding parameters and token sequence construction; and
compute, for each piece of response candidate data, a reliability index representing an estimated quality of the response candidate data.

5. The system according to claim 4,
wherein the circuitry selects, from the plurality of pieces of response candidate data, response candidate data to be transmitted to the second terminal device based on a ranking that combines the reliability index and an emotion state index derived from the analysis result data.

6. The system according to claim 5,
wherein the emotion state index is generated by performing an emotion analysis operation on the character-string data using an emotion classification model that outputs probability values for a plurality of emotion labels.

7. The system according to claim 1,
wherein the input data further comprises transaction data including payment information, and
wherein the circuitry is further configured to:
associate the response candidate data with the transaction data as screening input data; and
construct a primary-assessment token sequence comprising at least a portion of the transaction data.

8. The system according to claim 7,
wherein the circuitry is further configured to:
cause the trained neural network model to execute an inference operation on the primary-assessment token sequence to generate primary assessment result data indicating a risk classification of the transaction data.

9. The system according to claim 8,
wherein the circuitry is further configured to:
generate, based on the primary assessment result data and the transaction data, feature characterization data representing derived characteristics of the transaction data;
construct a final-assessment token sequence comprising the feature characterization data and the primary assessment result data; and
cause the trained neural network model to execute an inference operation on the final-assessment token sequence to generate final assessment result data.

10. The system according to claim 9,
wherein the circuitry is further configured to:
generate examination output data based on the final assessment result data, the examination output data comprising a classification code mapped from the final assessment result data; and
transmit the examination output data to the second terminal device via the communication interface.

11. The system according to claim 10,
wherein the feature characterization data comprises at least one of an anomaly score, a cross-border flag, and a high-amount flag derived by comparing the transaction data against statistical feature information computed from past transaction history associated with a user identifier.

12. The system according to claim 1,
wherein the circuitry is further configured to:
store the correction data and the response candidate data as history information; and
reflect the history information in subsequent construction of the token sequence to adjust output characteristics of the trained neural network model.

13. The system according to claim 12,
wherein the circuitry generates the token sequence to include at least a portion of the history information such that the response candidate data is consistent with multi-turn interaction between the first user and the second user.

14. The system according to claim 13,
wherein the circuitry is further configured to:
perform a semantic analysis operation on the character-string data to extract intent data and topic data; and
perform an emotion analysis operation on the character-string data to generate an emotion state index representing an estimated emotional state of the first user.

15. The system according to claim 14,
wherein the circuitry constructs the token sequence to include the emotion state index and the intent data such that the trained neural network model generates response candidate data adapted to the estimated emotional state of the first user.

16. The system according to claim 15,
wherein the response candidate data is generated such that the response candidate data comprises content estimated to increase a degree of reassurance and a degree of trust of the first user based on the emotion state index and the history information.

17. The system according to claim 16,
wherein the character-string data comprises content of a communication notebook transmitted from a guardian terminal device, the second terminal device is a teacher terminal device, and the second user is a teacher, and
wherein the response candidate data comprises a draft reply sentence to be presented to the teacher for modification before transmission to the guardian terminal device.

18. A system comprising:
circuitry configured to:
receive, via a communication interface coupled to a packet-switched network, input data comprising character-string data from a terminal device operated by a first user;
perform a semantic analysis operation and an emotion analysis operation on the character-string data to generate analysis result data comprising intent data, topic data, and an emotion state index;
select, from a template repository, template data corresponding to the intent data, and construct a token sequence by combining the character-string data, the analysis result data, the template data, and context data comprising past interaction history;
cause a transformer-based neural network model to execute an inference operation on the token sequence to generate a plurality of pieces of response candidate data, and compute a reliability index for each piece of response candidate data;
select, based on a ranking combining the reliability index and the emotion state index, response candidate data to transmit to a second terminal device via the communication interface;
receive, from the second terminal device, correction data representing a modification to the response candidate data by a second user; and
store the correction data, the response candidate data, and interaction outcome data as history information, and reflect the history information in subsequent construction of token sequences.

19. The system according to claim 18,
wherein the input data further comprises transaction data, and
wherein the circuitry is further configured to:
construct a primary-assessment token sequence comprising at least a portion of the transaction data, cause the transformer-based neural network model to generate primary assessment result data, generate feature characterization data based on the primary assessment result data and the transaction data, construct a final-assessment token sequence, cause the transformer-based neural network model to generate final assessment result data, and transmit examination output data based on the final assessment result data to the second terminal device.

20. A method performed by circuitry, the method comprising:
receiving, via a communication interface coupled to a packet-switched network, input data comprising character-string data from a terminal device operated by a first user;
performing an analysis operation on the character-string data to generate analysis result data;
constructing, based on the analysis result data, a token sequence for input to a trained neural network model, and causing the trained neural network model to execute an inference operation on the token sequence to generate response candidate data;
transmitting the response candidate data to a second terminal device via the communication interface; and
receiving, from the second terminal device, correction data representing a modification to the response candidate data by a second user.
